(19) United States
(12) Patent Application Publication
(10) Pub. No.: US 2003/0167135 A1
(43) Pub. Date: Sep. 4, 2003

(54) Non-linear modelling of biological activity of chemical compounds

(75) Inventor: Todd J.A. Ewing, Newark, CA (US)

Correspondence Address: BEYER WEAVER & THOMAS LLP, P.O. BOX 778, BERKELEY, CA, 94704-0778, US

(73) Assignee: Camitro Corporation

(21) Appl. No.: 10/034,663

(22) Filed: Dec. 19, 2001

(51) Int. Cl. G06F 19/00; G01N 31/00

(52) U.S. Cl. 702/22

(57) ABSTRACT

Models predict activity of chemical compounds by employing “transformed” descriptor values. The descriptors are transformed via transformation functions that convert the raw descriptor values to new values better representing the contribution of the descriptors to the activity in question. Typically, these transformation functions are non-linear parametric functions such as Gaussian functions or sigmoid functions. Typically, the model will employ at least two different descriptors, each transformed by its own non-linear parametric function.

### CROSS-REFERENCE TO RELATED APPLICATIONS

This patent application is related to U.S. patent application Ser. No. 09/368,511, “Use of Computational and Experimental Data to Model Organic Compound Reactivity in Cytochrome P450 Mediated Reactions and to Optimize the Design of Pharmaceuticals,” filed Aug. 5, 1999 by Korzekwa et al. (Atty Docket No.: CAMIP001); U.S. patent application Ser. No. 09/613,875, “Relative Rates of Cytochrome P450 Metabolism,” filed Jul. 10, 2000 by Korzekwa et al. (Atty Docket No.: CAMIP002); U.S. Provisional Patent Application No. 60/217,227, “Accessibility Correction Factors for Quantum Mechanical and Molecular Models of Cytochrome P450 Metabolism,” filed Jul. 10, 2000 by Ewing et al. (Atty Docket No.: CAMIP004P); U.S. patent application Ser. No. 09/902,470, “Accessibility Correction Factors For Electronic Models Of Cytochrome P450 Metabolism,” filed Jul. 9, 2001 by Ewing et al. (CAMIP004); and U.S. patent application Ser. No. 09/811,283, “Predicting Metabolic Stability of Drug Molecules,” filed Mar. 15, 2001 by Ewing et al. (Atty Docket No.: CAMIP005).. These patent applications, as well as any other patents, patent applications and publications cited herein, are hereby incorporated by reference in their entirety for all purposes.

### FIELD OF THE INVENTION

The present invention relates generally to methods, apparatus, and program products for predicting activity such metabolism rates from descriptors of physicochemical properties. More specifically, the invention pertains models that employ descriptors in relationships using non-linear parameteric transformation functions. The invention also relates to methods, apparatus, and program products for generating models that predict activity from such descriptors. The invention is particularly useful in developing models of cytochrome P450 enzyme metabolism.

### BACKGROUND OF THE INVENTION

There is a significant need for improved methods of predicting biological activity of chemical compounds. Such methods typically involve predictive models running on computers. The models themselves often fail to accurately account for the natural biological impact of certain physical or chemical descriptors of the chemical compounds. Drug discovery, and particularly ADMET/PK properties of compounds, is one endeavor where more accurate predictive methods and models would be highly valuable.

Drug development is an extremely expensive and lengthy process. The cost of bringing a single drug to market is about $500 million to $1 billion dollars, with the development time being about 8 to 15 years. Drug development typically involves the identification of 1000 to 100,000 candidate compounds distributed across several compound classes that eventually lead, to a single or several marketable drugs.

Those thousands of candidate compounds are screened against biochemical targets to assess whether they have the pharmacological properties that the researchers are seeking. This screening process leads to a much smaller number of “hits” (perhaps 500 or 1000) which display some amount of the desired properties, which are narrowed to even fewer “leads” (perhaps 50 or 100) which are more efficacious. At this point, typically, the lead compounds are assayed for their ADMET/PK (absorption, distribution, metabolism, elimination, toxicity/pharmacokinetic) properties. They are tested using biochemical assays such as Human Serum Albumin binding, chemical assays such as pK_{A} and solubility testing, and in vitro biological assays such as metabolism by endoplasmic reticulum fractions of human liver, in order to estimate their actual in vivo ADMET/PK properties. Most of these compounds are discarded because of unacceptable ADMET/PK properties.

In addition, even optimized leads that have passed these tests and are submitted for FDA clinical trials as investigational new drugs (INDs) will sometimes show undesirable ADMET/PK properties when actually tested in animals and humans. Abandonment or redesign of optimized leads at this stage is extremely costly, since FDA trials require formulation, manufacturing and extensive testing of the compounds.

The development of compounds with unacceptable ADMET/PK properties thus contributes greatly to the overall cost of drug development. If there was a process by which compounds could be discarded or redesigned at an earlier stage of development (the earlier the better), then great savings in money and time could be achieved. The current technology offers essentially no comprehensive method by which this can be done.

Ultimately, a computational technique or techniques for screening therapeutic drug candidates could save the industry many millions of dollars in wasted investment in compounds having poor ADMET/PK properties. So far, most attempts to employ such computational techniques have failed because either the technique is not sufficiently accurate or not sufficiently rapid. Generally, more complex techniques will be relatively accurate but slow.

Most models for predicting binding affinity to metabolizing enzymes work by analyzing either the steric interactions between metabolizing enzyme and substrate, or the common characteristics for a series of substrates. See, for example, Hunter, “A structure-based approach to drug discovery; crystallography and implications for the development of antiparasite drugs.” Parasitology 1997; 114 Suppl: S17-29; Gschwend et al, “Molecular docking towards drug discovery.” Mol Recognit March-April, 1996; 9(2): 175-86; Rao et al, “A Refined 3-Dimensional QSAR of Cytochrome P450 2C9: Computational Predictions of Drug Interactions,” Journal of Medicinal Chemistry; 2000; 43(15); 2789-2796; Afzelius et al, ‘Competitive CYP2C9 inhibitors: enzyme inhibition studies, protein homology modeling, and three dimensional quantitative structure-activity relationship analysis.” Mol Pharmacol. April, 2001;59(4):909-19.

While these modeling techniques are partially effective for modeling binding affinity of a limited set of molecules, they have difficulties when it comes to modeling all the possible classes of molecules that can bind to broad specificity enzymes such as the cytochrome P450 (CYP) enzymes, which likely metabolize 50% of all drugs at least partially. Further, these techniques are computationally intensive and therefore offer only low throughput analysis.

Faster techniques employing molecular descriptors have been proposed and developed to some extent. Molecular descriptors describe some aspect of the molecule in question. Examples include molecular weight, partition coefficient, number of hydrogen bond donors, etc. Generally, relatively limited ranges of molecular descriptor values define molecules that bind to a particular target or, more generally, represent good therapeutic compounds. Some of these ranges are used together in “rules of thumb” for predicting useful therapeutic compounds; e.g., the Lipinski Rule of 5. Like all rules of thumb, they are rather crude and their reliability is limited.

More sophisticated, descriptor-based models typically take the following form: A=α(desc₁)+β(desc₂)+γ(desc₃)+ . . . . In this expression, A represents the predicted activity of a compound, α, β and γ represent coefficients of descriptor terms used in the expression for activity, and desc₁, desc₂, and desc₃ represent the specific descriptor values for the compound under consideration.

Descriptor based models of this form unfortunately do not account for non-linear variations in the effect of a given descriptor on activity. Also, such models do not account for a problem that arises in which a particularly bad effect caused by one physicochemical property makes binding impossible. Rather, the above additive linear expression sums contributions for multiple properties, so that a compound having a very desirable value of logP but a very unfavorable value of molecular weight may be predicted to have an overall desirable activity. Thus, the model can give an unrealistically positive prediction of activity for cases where bad values of a single property kill all possibility of positive activity.

Consider the following example. Assume that the physicochemical properties molecular weight, logP, and formal charge are used as descriptors in a linear model that employs the raw descriptor values. Such model may do a good job of predicting activity in a limited linear region of activity space. However, the model rapidly fails outside this range. For example, a compound with large values of the molecular weight (e.g., 600), logP (e.g., 10), and formal charge (e.g., +5) might be a particularly unattractive drug candidate. But when analyzed using a linear model of the form A=α(MW)+β(logP)+γ(FC), it would appear to be a strong candidate (assuming that α, β, and γ are positive values).

In view of the foregoing, the development of fast and accurate models of substrate binding or specific ADMET/PK properties, and in particular those models that can be used to predict binding to cytochrome P450, would be highly beneficial.

### SUMMARY OF THE INVENTION

To address the needs set forth above, the present invention provides models that predict a biological or other activity of chemical compounds by using “transformed” descriptor values. The descriptors are transformed via transformation functions that convert the raw descriptor values to new values better representing the contribution of the descriptors to the activity in question In other words, the models are comprised of one or more descriptor transformation functions.

Typically, the transformation functions are non-linear parametric functions such as unimodal functions (e.g., Gaussian functions) or asymptotic functions (e.g., sigmoid functions). Typically, the model will employ at least two different descriptors, each transformed by its own non-linear parametric function. The transformation functions for different descriptors employed in a single model may be combined in various forms including linear and non-linear combinations. Generally, in the final model, one or more parameters will be associated with a single transformation function. The transformation function typically acts on a single descriptor, but may act on a vector combination of descriptors.

Preferably, the nonlinear parametric functions provide an analytical relationship that can be easily interpreted to show how a descriptor value affects the activity in question. A Gaussian transformation function, for example, will define a range or window of descriptor values in which the descriptor makes a contribution of significant magnitude to the activity. Outside this window, the transformed value rapidly approaches zero. Thus, if the model in question employs a transformed descriptor value in a product expression (i.e., the transformed descriptor is multiplied by other values in a model), a value of zero for the transformed descriptor value will return an activity of zero. This is typically the case for biological activity values such as binding probability. For example, for compounds having a molecular weight greater than a certain maximum or less than a certain minimum, the probability of binding to a particular receptor is essentially zero.

The present invention relates not only to models as described, but also to methods for developing such models and methods of using such models. Training sets, based on a sample of molecules with known activities, are used along with descriptors of the molecules in order to develop mathematical models of biological activity based on various techniques. The resulting models are then used to predict the biological activities of other molecules. The invention is particularly useful in developing simple models of cytochrome P450 enzyme metabolism.

Another aspect of the invention pertains to methods of creating a multivariate model for predicting the activity of compounds. Again, the model includes at least one non-linear parametric transformation function that transforms a descriptor of the compounds. The method may be characterized as follows: (a) fitting activity versus descriptor data for a training set of compounds using an optimization function; (b) identifying one or more descriptors whose parameters were driven below a threshold of significance to the model; and (c) eliminating the one or more descriptors identified in (b). The optimization function includes (i) a penalty term that drives a parameter of the transformation function toward a boundary value, and (ii) an error term that compares a predicted activity with an actual activity for members of the training set. In (b), the method determines whether the parameter in question was driven so far toward the boundary value that it is below the threshold level of significance. For example, when the width of a gaussian transformation function approaches infinity, the descriptor may be deemed insignificant and hence eliminated at (c).

To complete the model, the process may typically includes an additional operation of fitting a model with the descriptors remaining after (c). Such model may be cross-validated to de-select additional descriptors driven toward the boundary value during the cross-validation. Often the invention will be performed iteratively, so that (a)-(c) (and possibly cross-validation) are performed at least twice. Preferably, all or most of these operations are performed automatically by a computing device, without user intervention. Thus, in one preferred embodiment, multiple rounds of model fitting, cross-validation, and descriptor de-selection are performed automatically by a computing device, without user intervention, until the process converges to a model based on a minimum set of descriptor identified as significant for the model.

As one example, the parameter of the transformation function driven by the penalty term is the width of the non-linear parametric transformation function for each descriptor. In such case, the penalty term may include terms representing the reciprocal of the width of the non-linear parametric transformation function.

The optimization function may have other properties. For example, it may also include scaling factors, which specify the relative importance of the penalty term with respect to the error term. As another example, the optimization function may include one more parameter constraint terms that promote the numerical stability of the fit.

Yet another aspect of the invention pertains to computer program products including machine-readable media on which are provided program instructions for implementing the methods described above, in whole or in part. Any of the methods of this invention may be represented, in whole or in part, as program instructions that can be provided on such machine-readable media. In addition, the invention pertains to various combinations and arrangements of data generated and/or used as described herein.

These and other features of the present invention will be described in more detail below in the detailed description of the invention and in conjunction with the following figures.

### BRIEF DESCRIPTION OF THE DRAWINGS

FIG. 1 is a process flow diagram depicting some operations that can be performed as part of a process to generate models in accordance with this invention.

FIGS. 2A, 2B, and 2C are process flow diagrams depicting two general processes for generating models: one having a form in which transformed descriptors are summed and another in which transformed descriptors are not summed.

FIG. 3 is a graph showing a training data set that has been smoothed using kernal sampling and then fit to a unimodal transformation function.

FIG. 4A presents a histogram (left graph) of number of binding and “non-binding” compounds versus molecular weight and an associated Gaussian transformation function (right graph) obtained by fitting the data points in the histogram.

FIG. 4B presents graphs of an additive model form and a multiplicative model form, both in accordance with embodiments of this invention. Gaussian model in accordance with an embodiment of this invention. The expression includes actual Ki values, average Ki values for many drugs, and over-fitting constraints.

FIG. 4D is a list of initial parameters to use with the minimization function of FIG. 4C in accordance with one embodiment of this invention.

FIG. 4E presents a second exemplary minimization function for developing a multi-dimensional Gaussian model in accordance with this invention. This expression includes constraint functions that attempt to reduce model complexity and prevent over-fitting of the training data.

FIG. 4F presents a list of initial parameters for use with the minimization function of FIG. 4E, in accordance with one embodiment of this invention.

FIG. 4G presents a list of performance metrics, including a “descriptor focus,” that may be employed to automatically select certain descriptors, from among many potentially relevant descriptors, for use in models of this invention.

FIG. 4H is a process flow chart depicting one algorithm for automatically selecting descriptors and fitting appropriate models using such descriptors, in accordance with a specific embodiment of this invention.

FIG. 4I depicts an acceptable sigmoid transformation function and an associated optimization having a penalty term tending to drive the sigmoid width to zero.

FIG. 4J presents a list of initial parameters for use with the minimization function of the type shown in FIG. 4I, with a sigmoid transformation function.

FIGS. 5 and 6 are high-level flowcharts depicting methods for predicting the metabolic rate of a substrate molecule, starting with the specified descriptors of the substrate.

FIG. 7A presents a histogram (left graph) of number of binding and “non-binding” compounds versus logP and an associated Gaussian transformation function (right graph) obtained by fitting the data points in the histogram.

FIG. 7B presents a histogram (left graph) of number of binding and “non-binding” compounds versus formal charge and an associated Gaussian transformation function (right graph) obtained by fitting the data points in the histogram.

FIG. 7C presents (i) a data set of activity vs. descriptor values and (ii) a list of Gaussian parameters for transformation functions derived from the data set.

FIG. 7D presents a plot of pKi versus molecular size (left graph) for a training set and an associated Gaussian transformation function (right graph) obtained by fitting the data points in the pKi plot.

FIGS. 8A and 8B illustrate a computer system suitable for implementing embodiments of the present invention.

FIG. 9 is a block diagram of an Internet based system for predicting metabolic properties of molecules in accordance with an embodiment of the present invention.

### DETAILED DESCRIPTION

A. Introduction

The present invention pertains to methods, apparatus, and program code that use simple, rapidly executing models to predict the activity of compounds (e.g., the binding of various substrates, and their metabolites and precursors, upon interaction with an enzyme or other biological molecule). Examples of biological molecules of interest include enzymes, ion channels and pumps, and various receptors. Of particular interest are biological molecules that mediate ADMET/PK processes. The methods are equally applicable to biological molecules with broad substrate specificity (i.e., low substrate selectivity) and very narrow substrate specificity. Interesting examples include enzymes with broad substrate specificity such as monooxygenases (e.g., the CYP enzymes), glucoronyl transferases, and glutathione transferases. Other interesting examples include P-gp (a protein implicated in multi-drug resistance) and proteins that mediate active transport across the blood brain barrier.

The technique described herein provides broad generality and speed because of its use of general molecular descriptors, but also provides improvements in accuracy because of its treatment of the non-linear relationship of these descriptors to binding affinity. General purpose techniques to address the non-linear phenomenon, like neural networks and gaussian process modeling, can fit data to arbitrary accuracy but are notoriously difficult to interpret. The technique of this invention provides a theoretical framework to model the non-linear relationships directly and therefore arrive at a model that is highly informative in its representation.

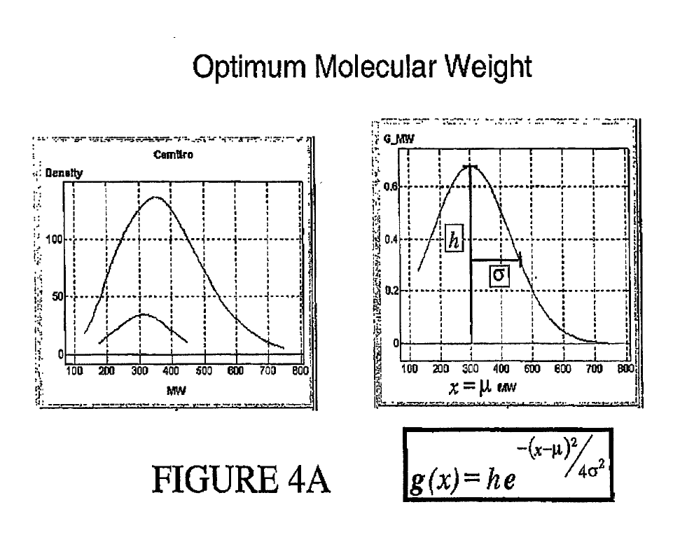

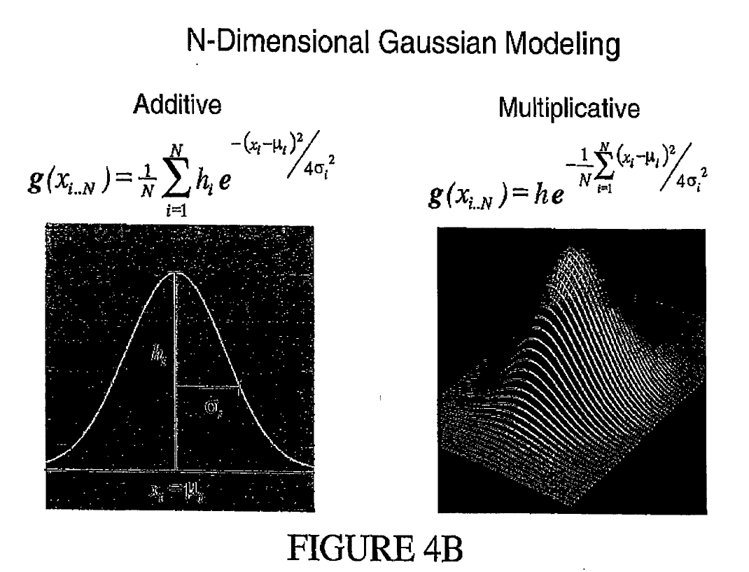

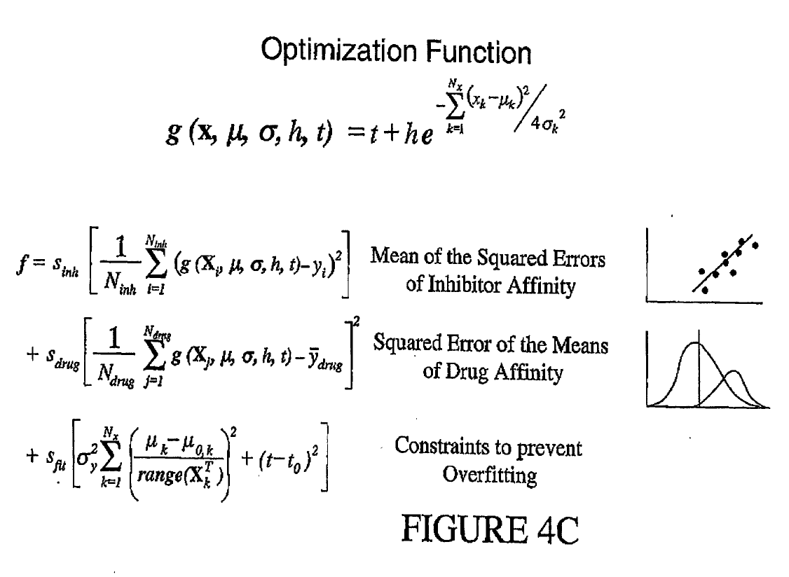

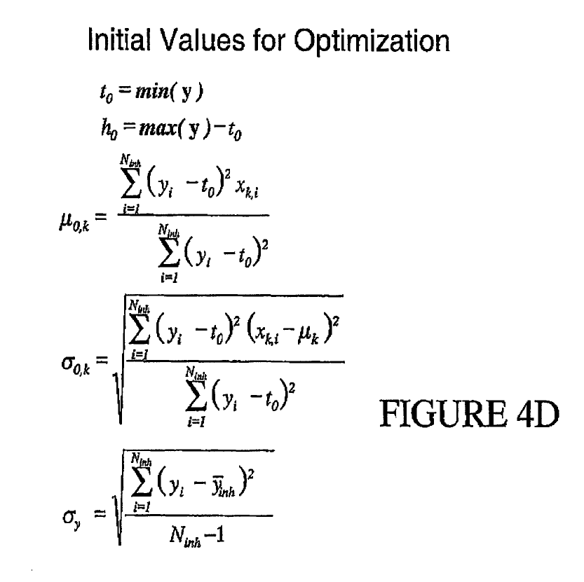

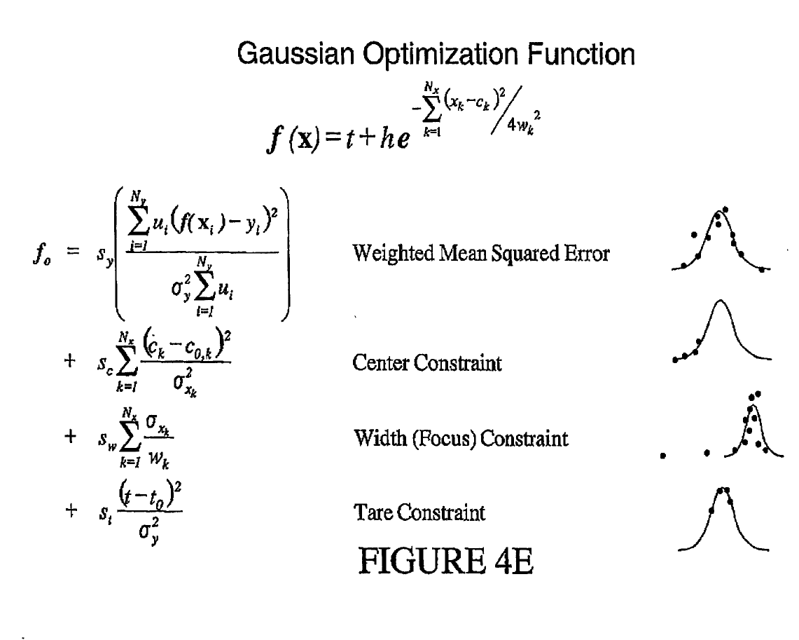

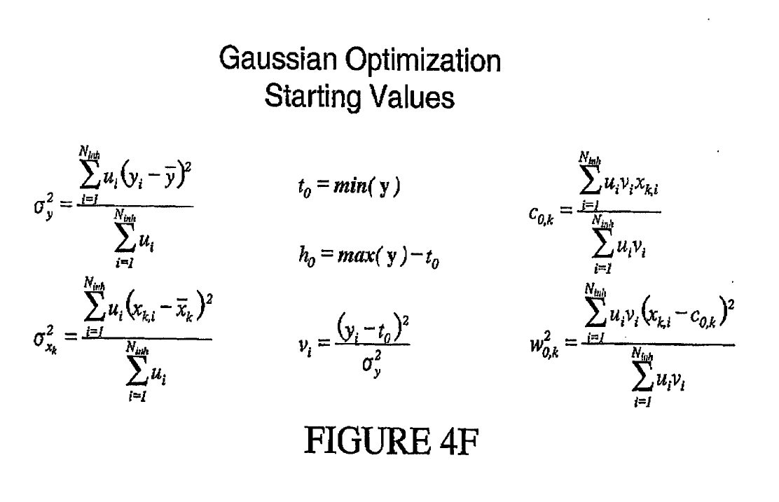

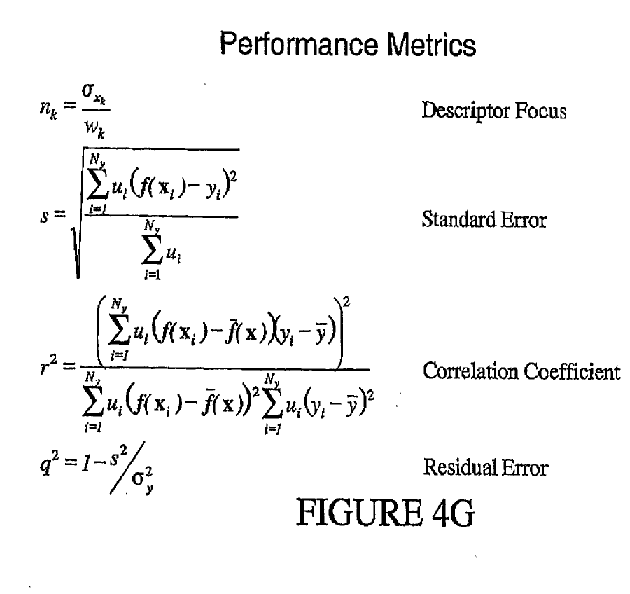

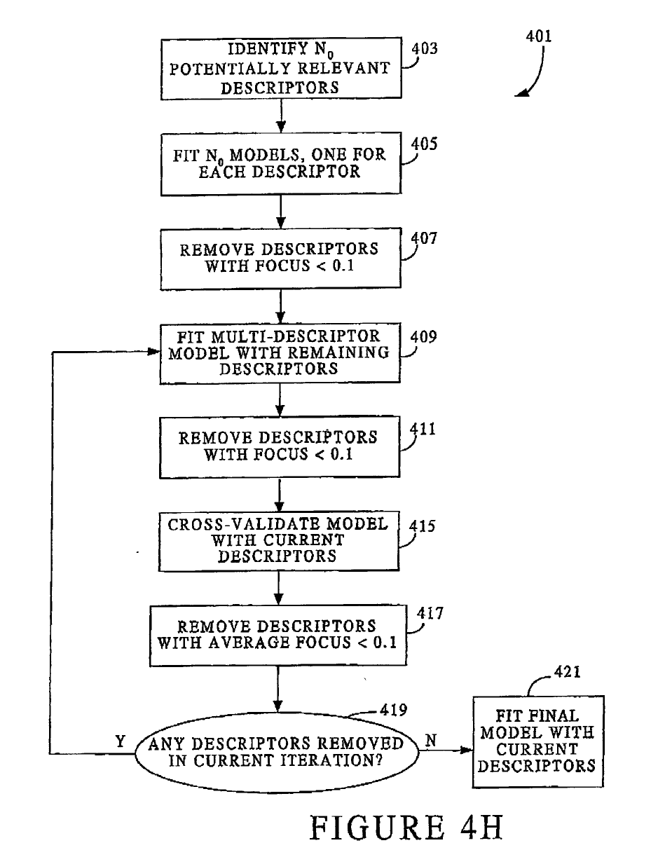

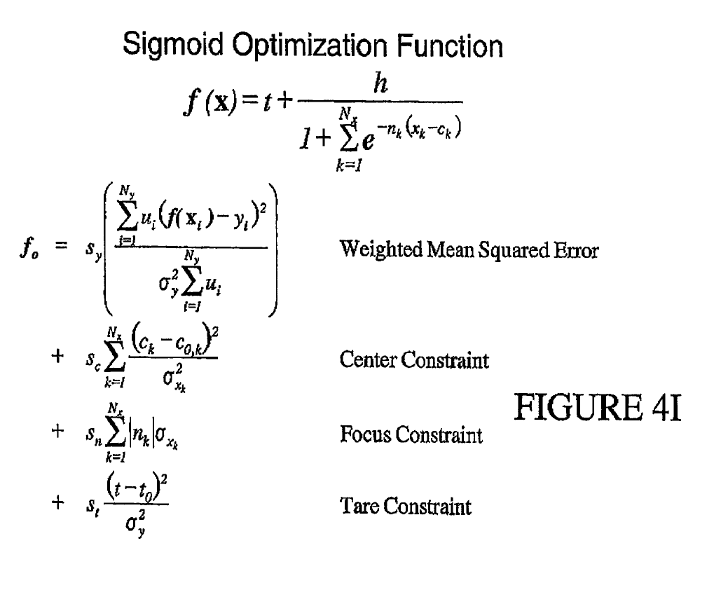

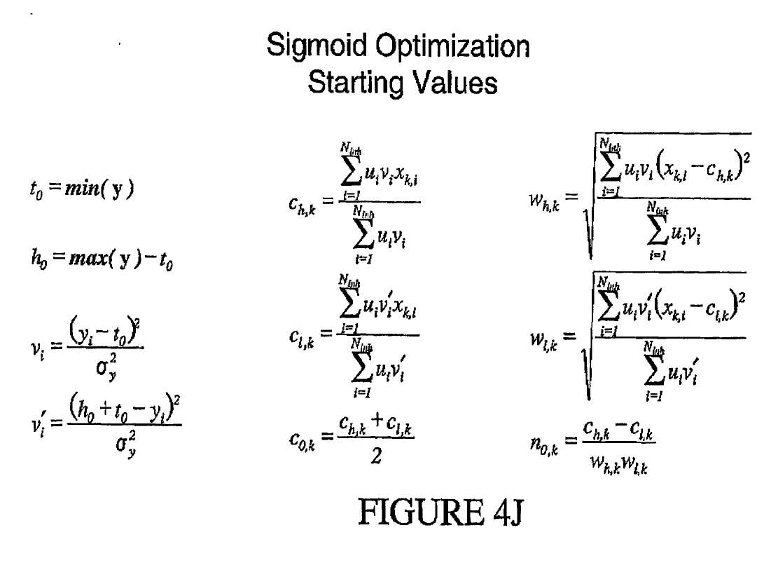

By way of example, FIG. 4B presents an additive Gaussian model and a multiplicative Gaussian (multidimensional Gaussian) model. In these models, the xᵢ represent the N different descriptors used in the model g(x_{i..}N) represents the activity predicted by the model (as a function of the N different descriptors), the σᵢ and the μᵢ represent the widths and centers, respectively, of the individual transformation functions for the individual descriptors, and h represents the maximum value of the Gaussian for individual transformation functions (additive) or the overall combined Gaussian (multiplicative). Note that when describing populations, a Gaussian is sometimes referred to as a “normal distribution” which has a “standard deviation” and a “mean.” In the context of this invention, one can usually view the Gaussian width as mathematically equivalent to a standard deviation and a Gaussian center as mathematically equivalent to a mean. Note however that this invention does not strictly apply to “normal distributions” in the conventional sense of that word.

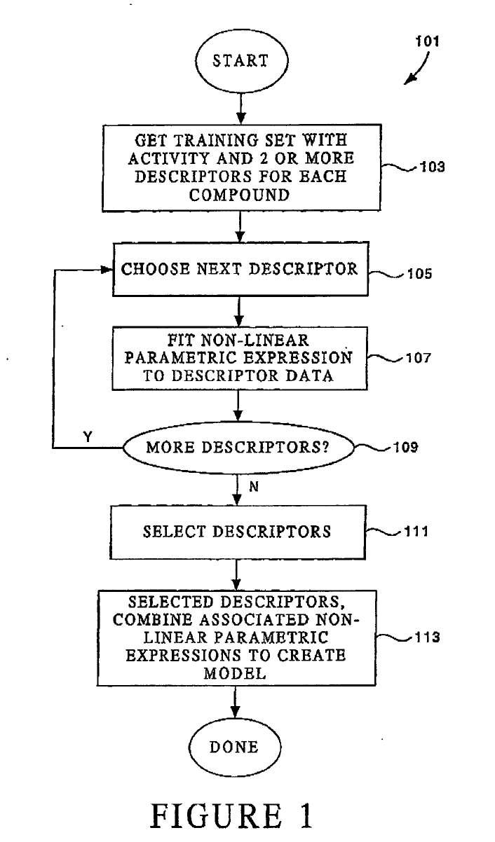

One aspect of the invention will now be described, at a general level, with reference to FIG. 1. As shown there, a process 101 for generating a model employs a series of operations beginning with data from a training set of chemical compounds and ending with the model. Typically, some or all operations of process 101 are implemented on a computing device. Further the operations may be performed in response to instructions provided on a storage medium or by a transport medium (e.g., instructions received over a network medium). Those instructions frequently take the form of program code governing operation of a processor or other computational device.

To generate a model of this invention, one will generally need an appropriate data set containing, for each compound in the training set, a value of activity and values of two or more descriptors. Frequently, the activity will be interaction with a biological molecule and the descriptors will represent physicochemical properties of the compounds. The full set of these activity and descriptor values for all members of the training set represents a data set, which is provided to process 101 at block 103. Typically, the data set is a pre-acquired set of data values provided in analog or digital format. In other embodiments, the data values may be obtained directly from experimental or computational generation, or from manual input.

In process 101, various descriptors are considered one at a time. Each one of them is analyzed to determine its relationship to the activity in question. Because the relationship is typically non-linear, the process identifies an appropriate non-linear transformation function for each descriptor. Descriptors transformed by such transformation functions have been found to be quite useful in multivariate models of activity. This is because the descriptors have a positive impact on activity over a limited range of values—and this impact varies non-linearly.

Given this, process 101 sequentially considers descriptors by “choosing” a next descriptor at 105. That descriptor will be provided as numerous pairs of data values, typically one pair per each compound of the training set. The data value pairs are the activity value of a compound and the descriptor value of the compound. When considered together, the data points (activity/descriptor) typically provide a non-random trend in the data. The process fits this trend to a mathematical expression at operation 107. Preferably, the expression is a non-linear parametric expression (i.e., a non-linear expression that includes at least one parameter other than the descriptor).

Process 101 identifies at least one such mathematical expression for each descriptor. Generally, each descriptor is considered separately. Hence, a loop is depicted in which the process determines whether additional descriptors are to be considered (109) and, if so, chooses the next descriptor at 105. But the invention is not limited to such sequential treatment of descriptors. In some embodiments, where the form of the transformation functions is already selected, all descriptors may be used together in a single optimization process to develop a model that includes the transformation functions for each descriptor. In such cases, the model form is typically “multiplicative” as described in more detail below. In these embodiments, blocks 107-109 may be dispensed with.

Returning to the depicted process flow, after all descriptors have been considered (decision 109 is answered in the negative), process 101 next selects particular ones of the descriptors from the data set (obtained at 103). See 111. In some cases, the process selects all descriptors and other cases it selects only a subset. Generally, descriptors are selected based on their ability to influence the activity in question and to do in a manner that does not strongly correlate with another selected descriptor.

Finally, from the selected descriptors, the process combines the associated non-linear expressions to create the model in question. See 113. In some embodiments, particularly where a multiplicative model form is employed, operation 113 effectively generates the transformation functions by solving for parameters associated with the various descriptors chosen for the model.

The resulting model employs not the raw descriptor values, but rather transformed descriptor values. The transformation of a given descriptor (via the expression obtained at 107) provides a new value indicative of the descriptor's direct influence on the activity in question. The model generated in accordance with process 101 can take many different forms—linear or non-linear, additive or multiplicative, etc. It is typically stored and/or transmitted as digital or analog instructions and/or as a data structure.

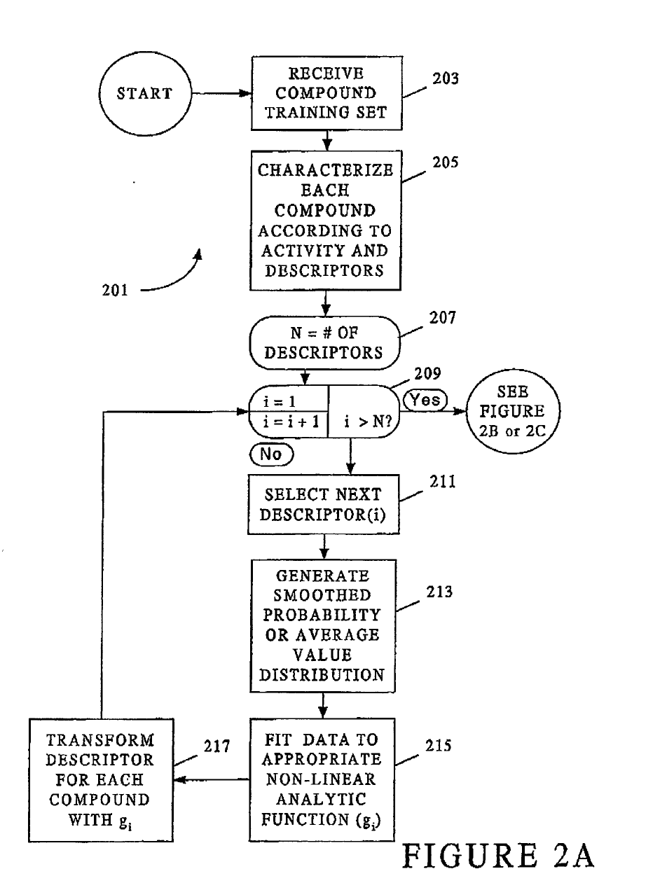

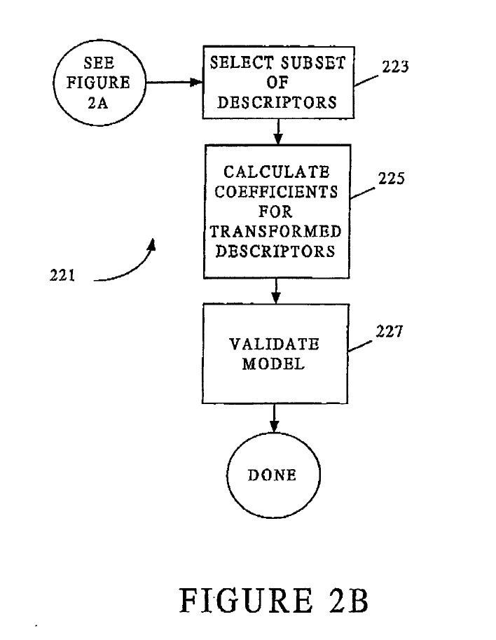

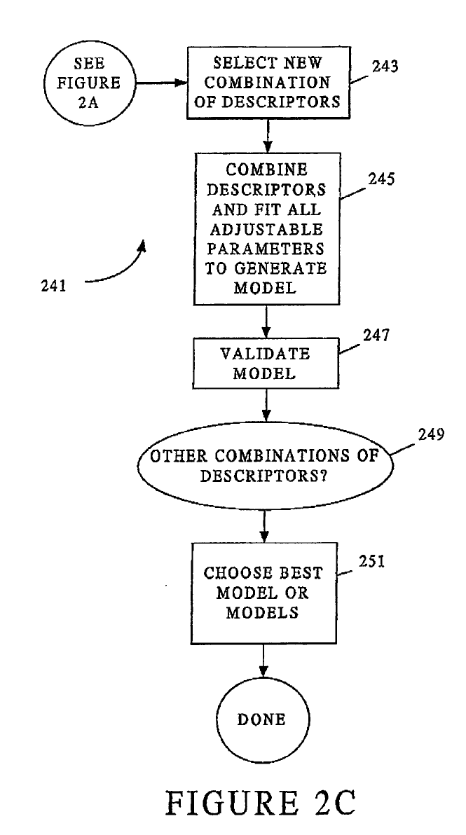

Certain aspects of process 101 will be described in considerable detail below, particularly with reference to FIGS. 2A, 2B, and 2C. For example, operations 103 and 111 will also be discussed more fully below. Further, operations 107 and 113 will be described in significantly more detail below.

The models of this invention may be used alone or in conjunction with other models. In many cases, the ultimate activity of interest is dictated by the binding strength of a compound with a biological molecule. In such cases, the models of this invention may be used alone. In other cases, such as metabolism, the reactivity of a site on a compound is a function of both an intrinsic electronic reactivity of the site (determined without regard to the metabolizing enzyme) and a binding affinity of the compound to the metabolizing enzyme. In these cases, the models of this invention can be used alone or in combination with another model that predicts intrinsic electronic reactivity. In certain embodiments, the models of this invention can be used as a screen to determine whether a compound in question binds to a metabolizing enzyme. If the screen predicts that binding is unlikely, the compound is not considered further; it is deemed to be not metabolized by the enzyme in question. If the screen predicts that binding is likely, the electronic reactivity model may determine the site-by-site reactivity (or overall reactivity) of the compound.

In all cases, the model requires descriptor values for the compounds in question. These are often obtained experimentally, as in the case of a partition coefficient or melting point. Although sometimes the descriptor values can be predicted computationally by analyzing a digital or analog representation of the compound. Regardless of how the descriptor values are obtained, the model employs them in an embedded non-linear transformation expression. A model operates on the transformed descriptor values to predict activity. Techniques for using models of this invention will be described in more detail below.

At this point, to assist in understanding the concepts presented herein, the following simple explanations are provided for some terms. The scope of the invention should not necessarily be limited by the following examples.

“Physicochemical property” (or sometimes just “property”) refers to a particular physical and/or chemical property of a compound under consideration. The property may pertain to the compound as a whole, a region or fragment of the compound, or individual atoms within the compound. Examples of whole compound physicochemical properties include partition coefficient (P), molecular weight (MW), formal charge (FC), van der Waals surface area associated with various types of atoms, total number of hydrogen bond donors/acceptors, etc. Examples of region specific physicochemical properties include precalculated properties (e.g., hydrophobicity) of generic molecular fragments obtained from molecules using fragmentation rules. Examples of atom specific physicochemical properties include chemical information about a site atom such as information about its neighbor atoms, its partial charge, its total charge, bond lengths, whether it is a hydrogen bond donor or acceptor, etc. Further examples will be set forth below.

For purposes of this invention, particularly relevant physicochemical properties are those that found to impact a particular “activity” of interest. For example, the hydrophocity and size of a compound often have a pronounced effect on the binding affinity of the compound to enzymes. Compounds having an octanol/water partition coefficient less than one and a molecular weight of less than 200 daltons seem to bind poorly with CYP450 enzymes.

“Descriptor” refers to a variable or value representing a property of a particular compound. Thus, the term is closely related to, and in a sense overlaps with, “physicochemical property.” Descriptors may be viewed as quantitative or textual representations of properties. They appear in expressions or models for predicting “activities” of a particular compound. A potentially infinite number of descriptors may characterize a compound. Multivariate models employ two or more descriptors to predict the activity of a compound.

“Activity” refers to an important characteristic of a compound. In a sense, an activity is like a “property” of a compound. However, in the context of this invention, activity usually refers to a biochemical, biological, and/or therapeutic behavior of a compound. Also, the activity of a compound is usually a characteristic that is to be predicted. Thus, an activity often serves as a dependent variable related to descriptors, which are independent variables. The models of this invention predict activity from descriptor values. Examples of activities that may be predicted with the models of this invention include binding affinity to particular biomolecules, such as metabolizing enzymes and transporters, as well as permeability across biological membranes.

Depending on how a model is constructed, activity may take the form of a specific numerical value (e.g., Kᵢ) or a threshold or filter (e.g., binds or does not bind).

A “Model” is a mathematical or logical representation of a physical and/or chemical relationship. Models may predict an activity from one or more descriptors of physical and/or chemical properties. In other words, such models treat an activity as a dependent variable and descriptors as independent variables. Thus, the model is itself a mathematical or logical relationship.

Models can take many different forms. They can take a very simple format such as a look up table or a more complex format such as a quantum chemical representation of an oxidation mechanism. Examples of the logical form of models include linear and non-linear mathematical expressions, look up tables, neural networks, support vector machines, Bayesian models, classification and regression trees/graphs, clustering approaches, and the like. In one preferred embodiment, the model form is a linear additive model in which the products of coefficients and transformed descriptors are summed. In another preferred embodiment, the model form is a non-linear product of various transformed descriptors (e.g., a multidimensional Gaussian expression).

Models can predict activity as a discrete event or a continuous range. A classification model predicts whether or not a discrete event such as binding will occur. A continuously variable model will predict the probability that the event will occur or the strength of the event (e.g., Kᵢ for enzyme substrate binding).

Models are typically developed from a training set of chemical compounds or other entities that provide a good representation of the underlying physical/chemical relationship to be modeled. Together, the activities and descriptors of compounds form members of the training set and are used to develop the mathematical/logical relationship between activity and descriptors. This relationship is typically validated prior to use for predicting activity of new compounds.

“Transformation Function” refers to a mathematical or other logical function that transforms a variable or set of variables from one form to another. In the context of this invention, transformation functions are employed to convert raw descriptor values of a physical/chemical property to probability values or other representations of the influence of the property on a selected activity. Transformation functions can be linear or non-linear, parametric or non-parametric. In this invention, particularly interesting transformation functions are non-linear parametric functions such as Gaussian distributions, sigmoidal distributions, hyperbolic functions, trigonometric functions, and the like. Unimodal transformation functions, such as Gaussian functions, are particularly useflul in describing biological structure-activity relationships in which there exists an optimum value of a particular molecular property to convey the activity. For example, binding affinity to an enzyme often requires that a molecule have size, shape, hydrophobicity and formal charge properties close to optimum values. In one example discussed herein, a transformation function gives a value of between 0 and Y based upon where a molecular weight value lies on a Gaussian distribution. Asymptotic transformation functions, such as sigmoid and hyperbolic functions, are particularly useful in describing biological structure-activity relationships in which there exists a threshold value of a particular molecular property needed to convey activity. For example, permeation and transport phenomena and some other kinetic phenomena exhibit saturation, in which the activity varies significantly near a threshold with respect to variation in a molecular descriptor, then approaches a maximum, beyond which changes in molecular descriptor values have little influence.

In the context of this invention, transformation functions are often embedded in expressions that serve as models for predicting activity. The transformation functions that comprise the model may be combined in various ways.

“Kernal Function” or “Weighting Function” refers to a function that weights or scales a variable, x, based upon the form of the kernal function. The general form of a weighted average is given by the following expression:

$$\overline{x} = \frac{{\sum }_{i} {w}_{i} {x}_{i}}{{\sum }_{i} {w}_{i}}$$

In this expression, Wᵢ is the kernal or weighting function and Xᵢ is the distribution of independent variables in a data set. Kernal functions can take many forms. Examples include Gaussian functions and square or triangular linear functions.

Sometimes a kernal function is used as a “sliding window” in a smoothing routine that smoothes a rough data set. This is referred to as a kernal sampling procedure. In one example, a data set of activity versus molecular weight may be rather rough. The smoothing routine employs a Gaussian kernal function. For each molecular weight to be considered in the data set, the Gaussian kernal function takes that molecular weight as a mean and calculates the weighted average of the activity. The resulting weighted average activity at that mean (specific value of molecular weight) serves as the new “smoothed” activity value at that point (the mean value). When each value of molecular weight has its corresponding weighted average activity calculated, a smooth data set of activity versus molecular weight results. Such smooth curve can be conveniently used to identify the form of a transformation function appropriate for molecular weight. In some cases, the smoothed data set may be fit to an analytical or other function (e.g., a transformation function). Of course, molecular weight could be replaced with any other descriptor or independent variable.

“Fitting” refers to the act of mapping a set of data points (a data set) to a mathematically or logically convenient format. That format is frequently a mathematical expression of linear or non-linear form. Look up tables may also be used if the values in the tables represent consensus values obtained from the data set. The expression (or other logical representation) resulting from the fit data generalizes the data in manner that can be used to predict activity from compounds or other entities outside the data set. Generally, fitting techniques are referred to as optimization or minimization techniques. Specific examples of fitting techniques include Newton's method, various splines (e.g., cubic splines), least squares, partial least squares, various regression techniques, as well as simplex, Monte Carlo, Tabu and genetic algorithm optimization techniques.

A “metabolic enzyme” refers to any enzyme that is involved in xenobiotic metabolism. Many metabolic enzymes are involved in the metabolism of exogenous compounds. Metabolic enzymes include enzymes that metabolize drugs, such as the CYP enzymes, uridine-diphosphate glucuronic acid glucuronyl transferases and glutathione transferases.

B. Generating a Model for Rapidly Approximating Activity

1. Overview

FIGS. 2A-2C together describe two processes for developing additive and non-additive models based on training sets. See processes 201, 221, and 241. These processes have considerable overlap with the general process 101 depicted in FIG. 1. They are provided to illustrate certain detailed embodiments of the invention.

Initially, in an operation 203, a training set of compounds is received. These compounds may be physical or “virtual.” Physical compounds have been synthesized and are available for experimental or computational analysis. Virtual compounds are physically available to the entity/person(s) generating the model. As such, they must be characterized computationally.

Each compound in the training set is characterized by its activity and a set of descriptors. See 205. These compounds are chosen to provide a significant sampling of the types of physicochemical properties and activities that the model is likely to encounter in practice. Activity is typically measured or calculated using a relatively slow process (at least in comparison to the speed at which the model resulting from process 201 can estimate activities). The trustworthy measures of activity may be obtained through experimental (e.g., binding assays) and/or theoretical techniques.

The descriptors characterize organic molecules based on physicochemical properties of the whole molecule or a portion of the molecule. The set of descriptors is chosen for use in addressing a particular type of biomolecular interaction (e.g., binding to a receptor). This is because some descriptors are more relevant to one class of interactions, while other descriptors are more relevant to other classes of interactions.

If the compounds are physical, the activity and possibly one or more descriptors is measured experimentally. If the compounds are virtual, then each of the descriptors is calculated using a computational process. This process may be as simple as calculating a molecular weight or as complicated as predicting activation energy using a quantum mechanical calculation. Roughly, operation 205 corresponds to operation 103 of FIG. 1.

The looping over distinct descriptors is treated in more detail in FIG. 2A. As illustrated, the loop process may be represented by two control operations 207 and 209. The logic of the invention is by no means limited to such process control. In the example, process 201 sets a variable N equal to the number of descriptors to be considered (207) and iterates over them (209). Iterative loop operation 209 initially sets an index value “i” equal to 1. It then determines whether the current value of i is greater than the value of N. If not, it performs the succeeding operations to create an analytic function describing the activity in terms of the descriptor. If i is not greater than N, the process will then select the next descriptor(i). See 211. It will then, optionally, create a smoothed probability distribution or average value distribution for the descriptor with respect to the activity under consideration. See 213.

Basically, activity versus descriptor value data points are arranged and smoothed using any suitable smoothing operation. The descriptor in question—for instance molecular weight—along with the activity, correspond to an (X, Y) data point for each training set compound. Plotting and/or binning the data points for all the compounds would create a histogram. It is preferable, however, to generate a continuous function for this data, which can be facilitated by, for example, assigning scores to the data points with a kernel function. Use of a kernal function in this manner does not, in itself, provide the non-linear transformation function. It merely “smoothes” the data to identify the form of an appropriate non-linear transformation function and/or to allow easy data fitting to yield the transformation function.

With that said, the data is fit to the appropriate non-linear transformation function, “gᵢ” for representing the data. See 215. As indicated above, one form of such function is a Gaussian function, which is suitable for many descriptors. The fit is made using any technique well-known in the art such as Newton's method of optimization.

Next, the process then transforms the descriptor for each compound using “gᵢ”. See 217. This puts the descriptors in a form that allows them to be used with other types of descriptors (comparably treated on other passes through loop 209) to generate the final form of a multivariate model. For example, the transformed descriptor values may be employed together to solve for coefficients in a linear “additive” model.

Generally, operations 213 and 215 together (or at least 215 itself) correspond to operation 107 of process 101. So in this embodiment, to fit activity versus a single descriptor for data set, one performs two operations. First, one smoothes the data set for the descriptor under consideration to identify the type of transformation function. Second, one fits the data to the transformation function. As indicated, a preferred example of the smoothing operation employs a kernal sampling procedure. In some embodiments, smoothing is not performed. Rather the raw data is directly fit to a pre-selected functional form to produce the transformation function.

The use of non-linear descriptor transformation functions (gᵢ) is one central feature of process 201. As mentioned, some currently known descriptor-based methods attempt to model affinity based on linear models of activity and using raw, untransformed descriptor values. For instance, Kᵢ(affinity) can be modeled using additive linear contributions from the descriptors, for example, Kᵢ=B₀+B₁(MW)+B₂(logP)+ . . . , where each descriptor is multiplied by a constant Bₙ to yield a contributing value. But looking at molecular size descriptors, and in fact most useful descriptors, it is clear that binding affinity cannot be linearly correlated with molecular size over the entire range of possible molecular sizes. Affinity is often optimal at or near some ideal molecular size and falls off at both higher and lower values. A linear model may be useful within a narrow range of descriptor values, but may become less accurate over wider ranges.

After all the descriptors have been transformed, the process is ready to proceed to generation of the final multivariate model. In FIG. 2B, a process 221 provides an additive model of transformed descriptor values, and in FIG. 2C, a process 241 provides a non-additive model of the transformed descriptor values. Typically, one or the other of processes 221 and 241 is performed.

Note that independently of whether the model is classified as additive or non-additive, it can be separately characterized as a classification model for predicting the probability of a discrete event (e.g., binding) or as a regression model in which the activity is predicted as specific value (e.g., Kᵢ). Obviously, if Ki values are not available for a training set (but information specifying whether the compound inhibits a particular enzyme is available), then the resulting model will be limited to yes/no or binds/does not bind classification.

With regard to FIG. 2B, a subset of the descriptors is chosen. See 223. Descriptors that strongly correlate with the actual activity under consideration are generally desirable, of course, but other considerations are also important. If two descriptors highly correlate with activity but also highly correlate with each other, then it might not be useful to use both. Other considerations include the computational cost of using the descriptor, the magnitude contribution of the descriptor to the affinity calculation, and how well sampled the descriptor is (if it is built on a small or large range of data points). Generally, operation 223 corresponds to operation 111 of process 101.

Next, coefficients are determined for the transformed descriptor equation, using a method such as PLS (partial least squares). See 225. Regardless of what technique is employed to generate the linear model, its form will be additive: A=A0+A₁X₁+A₂X₂+A₃X₃+ . . . . Here, A is the activity to be predicted, X₁, X₂, X₃, are the transformed descriptors, and A₁, A₂, A₃, etc. are linear coefficients derived for the model.

With the model now in hand, the process may test it (validation) against a particular test set of molecules. See 227. The model may be validated using traditional procedures such as cross-validation and independent tests. The molecules used in the test should have known activities and descriptors. The ability of the model to accurately predict these activities determines whether the model needs improvement. Assuming that the model does a good job of predicting activities, process 221 is complete. Assuming that the model needs improvement, then a revised training set or list of descriptors may be chosen. The revised set or list is chosen to handle the types of molecules or structural features that presented difficulty to the model.

Note that the model may be validated using internal validation (using the data employed to generate the model) and/or external validation (using data not employed to generate the model). If internal validation is employed, a “take one point out” technique or related technique may be employed, for example.

The current invention can also be used to create a non-additive model of activity. Such models are sometimes preferred because a single descriptor can be determinative of activity in appropriate cases. For example, binding affinity may be very low at molecular weights of greater than 1000, no matter what the other descriptors suggest. An additive contribution from another descriptor might result in an inappropriately large value for activity—even though the contribution of molecular weight to the overall activity in the model is essentially zero. Examples of non-additive models are multi-dimensional Gaussians, multiplicative functions, and exponential functions. In each case, two or more non-linear parametric transformation functions are embedded in the model. These functions transform raw descriptor values.

With regard to FIG. 2C and process 241, the previously calculated transformed descriptors (by gᵢ) are employed to generate and test various non-additive format models. The various models under consideration each employ a different subset of the descriptors in questions. In the end, the model with the best performance is chosen. Other embodiments of the invention do not require this competition among various model forms. A particular set or subset of descriptors may be locked in to the model from the very start—or at least early in the process.

In the embodiment of FIG. 2C, at 243, the process selects a subset of descriptors for consideration. These descriptors are chosen from among those first employed in 205. They may be chosen randomly or rationally. Either way, they are combined in a non-additive fashion at 245. Typically, this process involves fitting all the adjustable parameters—including both descriptor values and internal transformation function parameters (e.g., center, width, and maximum height if the transformation function is a Gaussian). This then generates the multi-descriptor non-additive model. The resulting function may be a multidimensional Gaussian as described in more detail below.

In one embodiment, the previously calculated parameter values for the gᵢs from 217 of process 201 are employed as seed values in generating the model. Various optimization techniques—e.g., Newton's method, truncated Newton's method, Runge-Kutta, Monte Carlo sampling, etc.—can be used to optimize the parameters of the multidimensional model.

The resulting model may be validated at 247. Validation may proceed by a conventional technique as described above in the context of FIG. 2B.

As mentioned, the process typically repeats for a number of other combinations of descriptors. So, at 249, a check for other descriptor combinations is depicted. The next descriptor combination is analyzed by directing process control back to 243. After processing all of these combinations, the best model or set of models can be chosen. See 251.

2. Choosing a Set of Descriptors

As indicated above, the models of this invention make use of specific descriptors for chemical compounds, particularly organic molecules. These descriptors should affect biological activity with high resolution. Particularly interesting descriptors will be described in more detail below.

Any organic molecule under consideration, whether used in a training set or an investigation set, is characterized using an appropriate set of descriptors. The descriptor characterization of the molecule is then used to either generate a model (the molecule is part of a training set) or predict activity (the molecule is part of an investigation set).

At some point in the model development process, one must select a set of descriptors to represent the activity in question. As depicted in the processes of FIGS. 2B and 2C, this selection may occur relatively late in the process of generating the model. The selection may be based on correlation to other descriptors, impact on activity, and/or ability to accurately predict activity, for example. In other embodiments, the descriptors may be set very early in the model generation process. In one specific embodiment, principal component analysis is employed to identify descriptors most relevant to a particular activity. PCA may be employed to analyze the data set in question and identify those descriptors having the largest variation. Principal component analysis is described, for example, in P. Geladi, Anal. Chim. Acta, 1986, 185, 1, which is hereby incorporated by reference.

Experience has shown that some of the most useful descriptors include partition values such as logP and logD; hydrogen-bond donor/acceptor counts; size based descriptors (e.g., molecular weight, calculated molar refractivity, atom counts, computed surface area, and computed volume), surface area, volume, length, longest length, charge-weighted surface area, and the like. More generally, the range of descriptors includes the following: sum of the atomic polarizabilities (including implicit hydrogens), sum of the absolute value of the difference between atomic polarizabilities of all bonded atoms in the molecule (including implicit hydrogens), total charge of the molecule (sum of formal charges), molecular refractivity (including implicit hydrogens), indicators of the presence of reactive groups (including, e.g., metals, phospho-, N/O/S—N/O/S single bonds, thiols, acyl halides, Michael Acceptors, azides, esters, etc.), polar surface area, van der Waals volume, molecular mass density (weight divided by vdw volume), area of van der Waals surface, total positive partial charge, total negative partial charge, relative positive partial charge, relative negative partial charge, total positive van der Waals surface area, total negative van der Waals surface area, total positive polar van der Waals surface area, total negative polar van der Waals surface area, total hydrophobic van der Waals surface area, total polar van der Waals surface area, fractional positive van der Waals surface area, fractional negative van der Waals surface area, fractional positive polar van der Waals surface area, fractional negative polar van der Waals surface area, fractional hydrophobic van der Waals surface area, and fractional polar van der Waals surface area. These and other descriptors are described in the documentation provided with the software MOE 2001.01, QuaSAR-Descriptor available from Chemical Computing Group Inc. of Montreal, Quebec. This documentation is incorporated herein by reference for all purposes.

3. Choosing a Training Set

In developing a model, one should carefully choose a training set. A large group of diverse chemical compounds should be used. Generally, a training set member may be any compound that has been synthesized or rendered virtually and has had its activities characterized experimentally or/and computationally. The specific compounds chosen for the training set may also be focused on a chemical structural space that is likely relevant to the model. Thus, a useful traning set may be comprised of compounds that possess structures generally similar to the structure(s) of a compound or compounds that will ultimately be screened with the model. For example, if the model pertains to drug metabolism, the training set compounds may be known drugs and/or drug-like compounds or other bioactive compounds.

The training set size depends in part on the amount of diversity among the members of the group. The diversity should reside in the descriptors of interest. Some descriptors are structural in nature. Structural “diversity” in the context of this invention means that the compounds of the set have a wide range of different functional groups and functional group environments. Such diversity may be obtained with a wide range of “scaffolds” and “building blocks” and/or a wide range of ring systems, substitutions, etc. As indicated above, the “structure” of a site includes not only the particular atom or moiety at the site, but also the chemical and physical milieu of the site. Thus, for purposes of developing a diverse training set, a diverse set of structures may include diversity in the neighboring atoms, ring systems, etc.

Often distinct training sets are used for developing separate types of models. Model examples include binding to CYP3A4, binding to CYP2D6, and binding to CYP2C9. The training set for binding to CYP3A4 should be diverse in the types of moieties relevant to CYP3A4 binding. Similarly, training sets for binding to CYP2D6 should be diverse in the types of moieties relevant to CYP2D6 binding.

4. Generating Models Employing Transformation Functions

As pointed out previously, transforming raw descriptor values is central to this invention. In a model, one or more descriptors may be transformed. But each descriptor to be transformed is typically analyzed separately, with its own transformation function. As mentioned, developing a transformation function for a particular descriptor may employ two operations: smoothing raw data to identify the form of the transformation function and fitting the data to the identified transformation function. In other embodiments, smoothing is not performed. Rather the raw data is directly fit to produce the transformation function.

As mentioned, activity versus descriptor value data points (descriptor1, activity) may be arranged and smoothed using any suitable smoothing operation. In one preferred embodiment, smoothing is accomplished by assigning scores to the data points with a kernel function. Use of a kernal function in this manner does not, in itself, provide the non-linear transformation function. It merely “smoothes” the data to allow easy data fitting to yield the transformation function.

Various kernal functions may be employed in the smoothing operation. Unimodal functions are preferred for many descriptors. In the simplest cases, such unimodal kernal functions are square functions or triangle functions that go to zero for descriptor values significantly different from a central value. A particularly preferred unimodal kernal function is a Gaussian function.

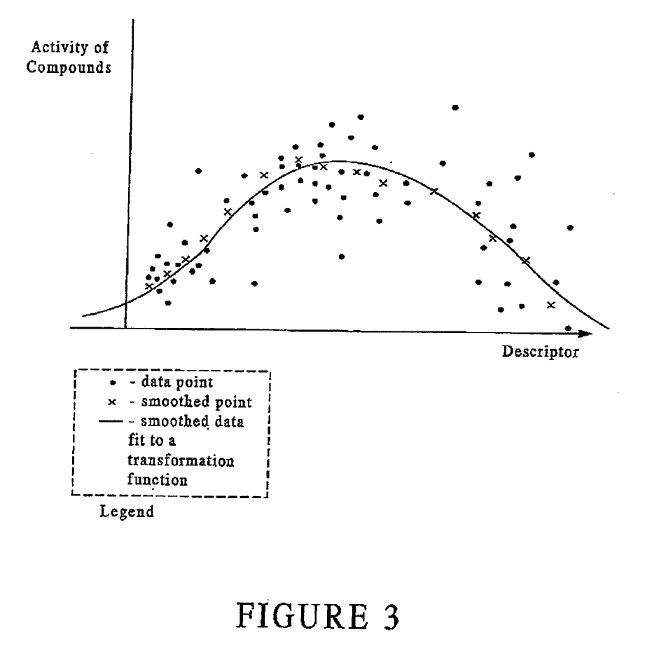

FIG. 3 depicts use of a smoothing operation to smooth a data set of activity versus descriptor value data points. As shown in the figure, the data points are represented dots. Each dot (data point) represents a different compound from the training set. To smooth the data, which is fairly rough, a weighted average is calculated at various values along descriptor axis. The weighted averages may be calculated using the expression set forth above, for example. In FIG. 3, the calculated weighted averages are represented as “x”s. As shown, the weighted average values capture the trend of the data points, and smooth out the variations of activity value at the various values of the descriptor under consideration.

As mentioned, the weighted average is generated using a kernal function such as Gaussian function or other unimodal function. For each descriptor value to be considered in the data set, the kernal function takes that value as its center and calculates the weighted average of the activity. Each point is then weighted appropriately by the kernal function. A weighted average is computed and serves as the new “smoothed” activity value at that point (the mean value). When each descriptor value has its corresponding weighted average activity calculated, a set of smoothed activity versus descriptor values results. The width of the kernal can be adjusted. Wide kernals produce greater smoothing of the data and facilitate analysis of global trends in the data. Narrow kernels facilitate analysis of local variations in the data.

While the data shown in FIG. 3 provides numeric activity values (e.g., Ki values), it could just as well represent “density” data such as the number of compounds in a data set that actually bind (without regard to how strongly the binding occurs). Such a representation would be a histogram. Such histograms can be smoothed and fit to a transformation function. Also of interest is to compare the number of actives to the total number of compounds within a local region of descriptor values. This probability distribution can be computed using a sliding window or kernal function. This analysis can facilitate the development of a classification model in which a local region of descriptor values can be identified which contains a statistically significant enrichment in active compounds relative to non-active compounds.

As shown in FIG. 3, the smoothed activity relationships and probability densities can be represented with an analytical function, often a unimodal transformation expression (shown as a solid curve in the figure). This is the non-linear transformation function, “gᵢ” computed as a function of the descriptor values. Generally, the expression is obtained by associating activity (or smoothed activity) with a specific descriptor. Association represents an attempt to find a relationship between the two groups of variables. One set of variables is the dependent set of variables and these are a function of the other set, the independent set of variables. In this invention, the dependent variables are activities such as binding to one or more specific CYP enzymes.

The form of the transformation expression should be chosen to balance accuracy and simplicity. Preferably, the transformation expression is a piece-wise continuous function (which may represent a kernal-smoothed activity to descriptor relationship in the training data). It has been found that unimodal expressions accurately model activity versus descriptor value for many activity/descriptor combinations. However, there is in principle no reason why other forms of transformation expressions could not be used as well. For example, sigmoidal functions, higher order polynomial functions, transcendental functions, discontinuous functions, look up tables, etc. may be appropriate for various activity/descriptor combinations. As mentioned, non-linear parametric functions are particularly preferred.

Note that the transformation functions employed with this invention preferably provide analytical relationships between the activity and the corresponding descriptor values. Thus, the transformation functions generally have their largest magnitudes for descriptor values that have the greatest impact on the activity in question. For descriptor values that have relatively little impact on activity, the transformation functions give correspondingly lower magnitudes. It is important to distinguish the use of non-linear parametric functions in this invention from how they are implemented in other modeling techniques such as neural network modeling and gaussian process modeling. Neural network models employ non-linear parametric functions (e.g., sigmoidal functions) as “activation functions” associated with the connection between each node in the model. Multiple layers of nodes are constructed, one layer for the input (with a corresponding node for each input descriptor being modeled), one layer for the output (with a corresponding node for each property being fitted) and one or more layers in between (with an arbitrary number of nodes in each). Every node in a layer is connected to all nodes in the subsequent layer. Every connection is described by an individual activation function. The number of required activation functions grows multiplicatively with the number of nodes in adjacent layers. These activation functions do not provide an analytical relationship between activity and the corresponding descriptor values; rather the overall network of connections and activation functions represents a complex multidimensional equation to empirically fit the data. In practice, it is very difficult, if not impossible, to understand the relationship between activity and descriptors when examining a neural network. That relationship is embedded in the complex of nodes and connections within the neural net.

Gaussian process modeling is another general-purpose non-linear modeling technique utilizing non-linear parametric functions (Gaussians). This technique utilizes an arbitrary number of gaussian functions distributed within a multidimensional descriptor space. A convenient technique is to position a gaussian function at the location of each training data point, the coordinates of which correspond to the specific descriptor values of the data point. The height and width of each gaussian is then fitted to approximate the local activity and density, respectively of the nearby data points. Like neural nets, the models generated with this technique do not provide an interpretable analytical relationship between activity and descriptor.

Transformation expressions for descriptors may be obtained via any suitable data fitting technique. Examples of such fitting techniques that may be used with this invention include Newton's method, various spline fitting techniques, partial least squares, etc. PLS (Projection to Latent Structures or Partial Least Squares) regression analysis can process large numbers of correlating descriptors while minimizing the risk of over-fitting.

FIG. 4A shows an example of a kernal-smoothed histogram (left graph) of number of compounds versus molecular weight and an associated Gaussian transformation function (right graph), representing the probability distribution, obtained by fitting the data points in the histogram. The parameters used to fit the Gaussian function (a non-linear parametric transformation function) include μ the mean, h the magnitude at the mean, and σ the standard deviation. Obviously, other non-linear parametric functions would have different parameters. The histogram will be described in more detail below.

After the one or more transformation functions have been identified for the one or more descriptors, a model for activity is generated from the data. This may be accomplished by finding an appropriate way to combine the various descriptors using the transformation functions so identified. It may also involve combining certain descriptors that remain untransformed. So the final form of a model may include transformed and untransformed descriptors or only transformed descriptors.

In the case of an additive model, coefficients are obtained for the transformed descriptors. See 225 of FIG. 2B. As mentioned, this may be accomplished using any appropriate technique, such as partial least squares. All transformed descriptor values (from the transformation functions using precalculated parameters) together with the activity values (from the traning set) are used to generate the coefficients. FIG. 4B shows, in the left graph and expression, the form of an additive model employing a linear combination of Gaussian transformation functions. In this example, as mentioned earlier, the xᵢ represent the N different descriptors used in the model, g(xᵢ.N) represents the activity predicted by the model (as a function of the N different descriptors), and the σᵢand the μᵢ represent the widths and the centers, respectively, of the individual transformation functions for the individual descriptors. The hᵢ represent the coefficient for the linear combination of each transformed descriptor produced by best fit multilinear regression, e.g. PLS.

In the case of a multiplicative model, typically one solves for all parameter values simultaneously using a minimization function. Examples of this minimization function are depicted in FIGS. 4C and 4E. Essentially, the raw descriptor values and activity values from the training set are used with the minimization function to iteratively solve for the adjustable parameters—the individual gᵢ parameters. As mentioned, minimization may be accomplished using various techniques such as Newton's method, truncated Newton's method, Runge-Kutta, Monte Carlo sampling, etc.

The ultimate form of a multiplicative model is depicted in FIG. 4B. As indicated above, the xᵢ represent the N different descriptors used in the model, g(xᵢ.N) represents the activity predicted by the model (as a function of the N different descriptors), the σᵢ and the μᵢ represent the standard deviations and means, respectively, of the individual transformation functions for the individual descriptors, and h represents the maximum value of the overall combined Gaussian.

In each of the above cases (additive and multiplicative), the transformation functions are given by exp(−(xᵢ−μᵢ)²/4σᵢ²). As indicated, the xᵢ represent individual descriptors such as logP, surface area values, molecular weight, etc. In some embodiments, the transformation function (Gaussian or otherwise) may operate on combinations of descriptors, rather than on single descriptors. In other words, the xᵢ arguments of the function are not raw descriptor values, but rather combinations of descriptors, possibly arranged as a vector through multidimensional descriptor space. Examples of such vector type descriptors are principal components obtained via principal component analysis, for example. Other linear othogonalization techniques can also be employed, such as Partial-Least Squares, to generate multi-descriptor vectors. Generally, the vectors produced by these techniques are linear functions and are orthogonal to one another. More broadly, any vector through descriptor space can act as a descriptor argument for the transformation function. Such multi-descriptor arguments can be represented generically as

Ax₁+Bx₂+Cx₃+Dx₄+Ex₅+ . . .

FIGS. 4C and 4D will now be described. These represent one approach to fitting a model. While FIGS. 4E-4F represent another approach to fitting a model. Note that in these figures, the index values for summations are changed. In FIG. 4B, the index values of i represent individual descriptors, while in FIGS. 4C-4I, the values of i represent individual compounds of the training set used to generate a model. In FIGS. 4C-4I, the index values of k represent the individual descriptors.

FIG. 4C depicts a minimization function, f, of a type that may be employed in the present invention to solve for parameters used in the transformation functions. Generally, minimization functions such as this one are appropriate for various forms of model expressions (additive and non-additive) and transformation functions. In this example, the minimization function is solving for the parameters of the function g, which is a multidimensional Gaussian, as indicated at the top of FIG. 4C. Using X as the argument (independent variables), the value of g returned is the predicted activity for the compound in question. The vector X is the set of descriptor values for the compound.

In a Gaussian type transformation function, the goal of the minimization function is to solve for at least the parameters μ, σ, and h. These are the same parameters that are depicted in FIG. 4B and in the expression at the top of FIG. 4C. Note that in the minimization function of FIG. 4C, the parameters μ, σ, are vectors. The components of the vectors are the values of these parameters (center and width) for each of the descriptors employed in the model. As will be explained in more detail below, the parameter t is also solved for during the minimization operation. This parameter is used to represent the starting, or minimum, value in the activity, whereas h represents the maximum extent to which activity deviates positively from the starting value of t.

During minimization, the value of the function f is minimized iteratively. When minimization is complete, the best fit values of the parameters μ, σ, h, and t should result. As indicated above, minimization can be accomplished using any suitable minimization technique such as Newton's method. During each iteration, the values of the parameters μ, σ, h, and t are changed in a direction predicted to minimize the value of f. The manner in which the values are changed from iteration to iteration is determined by the minimization technique employed.

In the expression depicted in FIG. 4C, the minimization function has three components (or terms). The first term of the function minimizes the transformation function, g, with respect to numerical activity data for the individual compounds of the training set.

The training set compounds used for this first term must have numerical activity values available. In this example, the compounds in the training set may be inhibitors of a compound such as a CYP enzyme. Thus, the activity values may be provided in the form of Ki or logKi values.

The second term is employed to minimize the difference between the function g and an average activity value expected over a particular collection or class of compounds. In this case, those compounds are drug compounds. The idea here is to use compounds for which individual values of activity are unknown, but an expected average value of activity across the class of compounds is known. This effectively allows one to employ a larger training set that includes both compounds for which actual activity values are known and other compounds for which such activity values are unknown.

The final term in the expression of FIG. 4C provides a constraint to prevent overfitting. In the example of FIG. 4C, the last term provides constraining parameters t₀ and μ₀, whose purposes will be explained in detail below.

Regarding the first term of the minimization function, it may be employed as the only term of the minimization function in many embodiments. When this is the case, the parameter sᵢₙₕ is not required.

In the first term of f, the summation is performed over the index i, which identifies the individual members of the training set compounds for which activity values are known. In the expression, yᵢ is the activity value in question for the individual member compounds of the training set. The activity value could be a continuously varying number suitable for a regression model, or a discrete category value suitable for a classification model.

Also in the first term, Nᵢₙₕ represents the number of compounds in the training set for which such activity values are known, g is the predictive model function of interest (a multidimensional Gaussian function in this case) the vector Xᵢ is the set of descriptor values for compound i, μ, is a vector of center values for the Gaussian transformation functions of each of the descriptors, σ is a vector of width values for the Gaussian transformation functions of the individual descriptors, and h is the height of the multidimensional Gaussian function. See the graphs in FIG. 4B for a graphical explanation of the function parameters.

As mentioned, a goal of the second term of the expression is to effectively extend the size of the training set with compounds for which no numerical activity value is known. In the case of known drug compounds, it is presumed that most have a pKi (−log₁₀ Ki) value with respect to a typical CYP enzyme (e.g., CYP2D6) of approximately 2.5to 3.

In the second term, a summation is performed over j different drug compounds in the training set. Each term of the summation is associated with a different drug compound from the training set. And each such term is the Gaussian transformation function for the compound under consideration. The summation is divided by the number of drug compounds to compute the average predicted activity. The difference between the average predicted activity and the value of y bar is squared so that as f is minimized, the deviation between average activity and expected average activity tends toward zero. This minimization is accomplished, with respect to the second component of f, by providing accurate values of the parameters μ, σ, h, and t, the same parameters appearing in the first component.

Again, the variable Xⱼ represents a vector of descriptor values for compound j, μ represents a vector of mean values for the Gaussian transformation functions associated with the various descriptors, σ represents a vector of standard deviation values associated with the Gaussian transformation function associated with the various descriptors, and h represents the overall magnitude of the multidimensional Gaussian function. As indicated, the μ, σ, and h parameters are identical in the first and second components of the expression for f. And the function g is also identical between these two terms. See the expression for the multiplicative form in upper right of FIG. 4C.

The term N_{drug} represents the number of drug members of the training set. Again, the training set in this example is comprised of (i) known inhibitors of an enzyme (e.g., CYP2D6), for which numeric values of pKi are known (first term of the expression for f) and (ii) known drug compounds, for which such numeric values are not known (second term of the expression for f).

The last term of the minimization function serves to constrain the variations in the parameters t and μ during fitting. It has been found that with some training sets, these parameters vary over unacceptably wide ranges in response to very minor changes in the training set. Simply removing one member of the training set or adding another member of the training set can cause these unacceptably wide fluctuations during fitting. Introduction of the terms μ_{0,k} and t₀ helps to constrain the variation of these parameters during fitting.

In the third term of the expression, σ_{y} is introduced to ensure that the units of the third term of the minimization function match the units of the first and second terms. Those units are pKi². In one specific embodiment, the value of σ_{y} is selected as the standard deviation in pKi for all inhibitor compounds in the training set.

In the third term of the expression, μ_{0,k} is a constant representing a initial value of μ for descriptor k. Note that k is the index designating individual descriptors of the multidimensional Gaussian functions. In one specific embodiment, μ_{0,k} is obtained as a weighted average of the values of descriptor k in the portion of the training set having numerical Ki values. The weight used in the weighted average is (pKi)². Thus, μ_{0,k} is a constant that does not vary during the fitting procedure. In contrast, μₖ is a variable representing the mean of descriptor k. Each μₖ corresponds to one component of the vector μ that appears in the first and second terms of the minimization expression. Note that, in the second term, the difference of μₖ and μ_{0,k} is divided by a range parameter. This range represents the difference in the maximum and minimum values of the descriptor in question. It is divided by a function of the transpose of descriptor values, X, comprised of columns differentiated by descriptor types and rows differentiated by specific molecules of the training set.

The parameter t₀ is a constant representing the initial value of t. See the expression for g appearing at the top right of FIG. 4D. In the depicted example, the value of t is a parameter to be fit during the minimization routine. It is constrained by a constant t₀ during the fitting. The value of the constant t₀ can be chosen somewhat arbitrarily. In a preferred embodiment, it is reasonably close to a minimum expected value of the activity in question; pKi in this case. In a specific embodiment, t₀ is set to be the lowest value of pKi seen in the training set. Typically, this value will be somewhere between about 2.3 and 3.0.

In the depicted example, weighting coefficients sᵢₙₕ, s_{durg}, and s_{fit} are employed to provide weights to the various terms of the minimization expression. These can be arbitrarily chosen to bias the minimization operation toward one or more of the terms of f. Typically, though not necessarily, the first term, which is based on actual numeric values of the activity, is given the greatest weight. In a specific example, the weights chosen are sᵢₙₕ=3, s_{drug}=1, and s_{fit}=1. Of course, the invention can be practiced without one or more of these weighting terms. In addition, one or two of these weighting coefficients can be set to zero, which effectively removes the corresponding term from consideration.

Note that during the iterative minimization operation, the values of h, t, and the vectors μ and σ vary incrementally from iteration to iteration. However, initial values for each of these parameters must be chosen. Preferably, the initial values are reasonably close to the final values. This ensures that the process converges relatively rapidly and that the solution does not get stuck in a local “as opposed to global” minimum. In one embodiment, the initial values of μₖ are set equal to the values of the constant μ_{0,k}. Similarly, the initial value of t is set equal to the value of the constant t₀. After the first iteration, the values of μₖ and t will vary from their initial values, and they will continue to vary during the duration of the minimization routine. In one preferred embodiment, the initial value of h is set equal to the greatest value of pKi in the training set minus t₀. The initial values of σ_{0,k} are weighted averages of the deviations of each descriptor across the members of the training set having pKi values. Again the weighting is equal to pKi² for each data point. FIG. 4D shows sample expressions for each of the initial values used in the optimization.

FIGS. 4E and 4F depict another optimization function that may be employed to solve for the parameters used in non-linear models of this invention. In many ways, the function depicted in these Figures is similar to the function depicted in FIGS. 4C and 4D. However, some terms of the function have been recast.

As shown in FIG. 4E, a minimization function ƒ₀ includes four terms. The first term, labeled “weighted mean squared error” corresponds to the first term of the minimization function 4C. The second and fourth terms depicted in FIG. 4E together correspond to the third term of FIG. 4C. The third term in the minimization function ƒ₀ is new. It functions to constrain the width of Gaussian transformation function to relatively large values. As will be explained, this term can be used to facilitate a selection algorithm, which removes descriptors that do not have a pronounced effect on activity. Finally, note that the second term for the minimization function of FIG. 4C is not present. In an alternative embodiment, that term is incorporated in the minimization function of FIG. 4E.

Note that the terms in the function ƒ₀ are made dimensionless. This is in contrast to the minimization function of FIG. 4C, which had units of log₁₀ Kᵢ.

Regarding nomenclature, certain changes appear in FIG. 4E. First, the basic function represented by the model is given by “f(x), rather than g(x, μ, σ, h, t). Also, the Gaussian center is identified by the symbol cₖ, rather than μₖ, and the Gaussian width is denoted by the symbol wₖ rather than σₓ.

Each of the four terms shown in the minimization function ƒ₀ has its own coefficient or weight. These are s_{y}, s_{c}, s_{w}, and sₜ for each of the four terms respectively. These coefficients serve the same purpose as the coefficients sᵢₙₕ, s_{drug}, and s_{fit} employed in the optimization function of FIG. 4C. That is, they scale or weight the various terms of the minimization function ƒ₀. In one specific embodiment, the value of s_{y} is 5, the value of s_{c} is 0.1, the value of s_{w} is 1, and the value of sₜ is also 1. Generally, the values of these coefficients will vary depending upon the number of observations (training set compounds) and the number of descriptors.

Returning now to the first term of the minimization function ƒ₀, is provided to give an accurate fit of the available data. The form of this term is essentially identical to the form of the first term of the expression shown in FIG. 4C. However, each observation is weighted by a factor uᵢ. In a typical embodiment, the value of uᵢ is set to 1 for each observation. However, it may sometimes be desirable to give extra weight to certain observations in a training set. For example, the training set may be biased in favor of compounds having a narrow range of activity values. Those members of the training set having activity values outside of this narrow range might be under-represented in the set and therefore afforded extra weight (via appropriate values of the uᵢ) to provide a more balanced training set.

Note also that the first term of the optimization function of FIG. 4E includes a weighted average variance, σ_{y}² defined as shown in FIG. 4F. This factor is simply the variance in activity across the training set, as weighted by the factor uᵢ. In the first term of the FIG. 4E expression, the weighted average variance is used to scale the term and render it dimensionless.

The second term of the FIG. 4E optimization function serves the same purpose, and has essentially the same form, as the beginning portion of the third term in the FIG. 4C optimization function. Its purpose is to ensure that the center of the Gaussian lies within the range of observations. This prevents the fitting function from selecting a Gaussian in which all the data points are fit to a “tail” of the Gaussian.

In the second term, the optimization function is initialized by setting the current value of cₖ equal to c_{0,k}. Because the second term includes the difference of cₖ and c_{0,k}, the value of the second term is 0 during the first iteration. Thereafter, as the minimization routine attempts to accurately fit cₖ, the second term serves to constrain the value of cₖ to a range as close as possible to c_{0,k}. As shown in FIG. 4F, c_{0,k} is a weighted average value of the descriptor in question, over all observations. The weighting is performed with the factor uᵢ (described above) and a factor vᵢ. As shown in FIG. 4F, vᵢ is a weighting factor giving higher weights to observations having larger magnitude activity values.

Note that the second term is scaled by a weighted average variance in the descriptor under consideration, σₓₖ². As shown in FIG. 4F, this factor has the same mathematical form as the weighted average variance in activity, σ_{y}². It renders the second term of ƒₒ dimensionless.

The third term of the optimization function ƒ₀ attempts to drive the widths (wₖ) of the Gaussians to infinity. Only those descriptors having strong influence on activity will be able to withstand the drive toward large widths caused by this third term, which is a “penalty function.”

Initially, during the first iteration, the value of wₖ is set to w_{0,k}, having a form as shown in FIG. 4F. During subsequent iterations, the value of the wₖ parameters is allowed to vary. During those iterations, the value of wₖ for many descriptors will grow very large in order to minimize the value of the third term. But, for those descriptors having a strong influence on activity, the first term will constrain the values of wₖ to relatively small magnitudes.

The final term of the optimization function, ƒ₀, is identical to the latter components of the third term in the optimization function of FIG. 4C. The only difference is that the fourth term of the FIG. 4E expression is made dimensionless by the weighted average variance in activity, σ_{y}². As explained above, this serves as a tare constraint during fitting.

As indicated above, the optimization function, f₀, depicted in FIG. 4E can be employed to selectively remove relatively unimportant descriptors, thereby simplifying the final form of the model. To this end, the “quality” of any given descriptor and of models resulting from a particular combination of descriptors must be assessed. Various performance metrics for making such assessments are depicted in FIG. 4G.

As shown in FIG. 4G, performance metrics that may be employed include a “descriptor focus,” the standard error, the correlation coefficient, and the residual error. As shown, the definitions of standard error, correlation coefficient, and residual error are those commonly understood in the field, but with the weighting factor uᵢ applied to individual observations.

A new parameter, the descriptor focus, is given by a ratio of the weighted average standard deviation in descriptor values (square root of the weighted average variance) over the “width” associated with a descriptor in question. In the case of a Gaussian transformation function, that width is wₖ. More generally, for sigmoidal transformation functions and other parametric non-linear transformation functions, the width may take other appropriate forms.

One exemplary algorithm for automatically selecting descriptors for non-linear parametric models of this invention is depicted in FIG. 4H. The algorithm there will be described with reference to the optimization function ƒ₀ of FIG. 4E. Understand, however, that other optimization functions may be employed. Further, independently of the optimization function employed, non-Gaussian transformation functions may be employed in the models being developed. In general, the optimization function employed should include a penalty term, which tends to drive a parameter of the transformation function toward infinity or some other meaningless value. In the example of FIG. 4E, the transformation function is a Gaussian and the parameter in question is the Gaussian width. In the selection algorithm of FIG. 4H, the algorithm de-selects descriptors having small values of descriptor focus.

Turning now to the specific algorithm depicted in FIG. 4H, a model-building process 401 begins at 403, where the algorithm receives N₀ potentially relevant descriptors. This list of descriptors may be human and/or machine generated. The descriptors may be chosen arbitrarily or based on some underlying physical understanding.

Each one of these potentially relevant descriptors is used to develop a separate model. Thus, as depicted at 405, N₀ separate models are generated, one for each descriptor. For each of these models, the descriptor focus is calculated. If the value of descriptor focus is below a predefined value (e.g., 0.1), the algorithm de-selects the corresponding descriptor as indicated at 407. Such descriptors are assumed to contribute only noise. In an alternative embodiment, the algorithm calculates the correlation coefficient and/or residual error (in place of descriptor focus) for each descriptor. It de-selects those descriptors for which the correlation coefficient and/or residual error is below a defined value (e.g., 0.02).

Next, the algorithm builds a single multi-descriptor model with the descriptors remaining after 407. See 409. In one preferred embodiment, the algorithm builds the model using the optimization function ƒ₀ shown in FIG. 4E.

Next, the process logic calculates a descriptor focus for each descriptor employed in the model generated at 409. At 411, the algorithm de-selects certain descriptors by removing those with focus values less than a predefined value (e.g., 0.1).

Next, the current set of descriptors is used to cross-validate the model. See 415. Any of a number of cross-validation techniques may be employed. In a preferred embodiment a “jack knifing” or “boot strapping” cross-validation technique is employed. In one particular preferred embodiment, a seven way cross-validation technique is employed. In this technique, six sevenths of the observations in the training set are retained to fit a model. The remaining one seventh of the observations are used to test the model. This process is repeated for six other combinations of training set and testing set. In each case, a different seventh of the original training set is set aside as a testing set.

For each of the cross-validation runs, the process logic calculates a descriptor focus for each descriptor within the current set of descriptors. The algorithm retains only those descriptors having a focus value greater than a predefined value averaged over each one of the runs. See 417. In an alternative embodiment, the algorithm retains only those descriptors for which the descriptor focus value is greater than a predefined value over every one of the runs (i.e., the focii are not first averaged before checking against the predefined value).

When all descriptors employed in the cross validation runs of 415 and the model generation operation 409 withstand de-selection by meeting their respective criteria, the algorithm has settled on its final set of descriptors. This decision is represented at 419 where the process logic determines whether the set of retained descriptors has not changed over the current iteration. (For this purpose, an iteration has blocks 409, 411, 415, and 417.) Assuming that the descriptor set has remained constant over the current iteration, process control moves to 421 where it fits a final form of the model with the current descriptors.

Assuming that the cross validation 415 or generation 409 produces one or more descriptors that are removed at 411 or 417, then decision 419 is answered in the negative. At that point, the process logic returns to block 409, where the current set of descriptors is utilized to generate a new model. The descriptors are again scrutinized at 411. From there, the remaining set of descriptors is cross-validated at 415 as described above. Ultimately, the loop through 409, 411, 415, 417, and 419 will end when the set of descriptors presented at 409 remains after 417.

Again, note that the concept of a “width” of the non-linear transformation function is general. It is does not apply exclusively to Gaussian transformation functions. As is well known in the art, sigmoid functions also possess a “width.” Other non-linear parametric transformation functions have associated parameters that can be driven toward particular values by penalty function such as the third term of the ƒ₀ optimization function. In each case, an algorithm like that depicted in FIG. 4H will de-select those descriptors where the parameter in question was effectively driven toward an outer boundary by the penalty term. A descriptor focus or other means of characterizing the extent to which the penalty term has driven the parameter toward this boundary allows the algorithm to identify descriptors for exclusion.

FIG. 4I depicts an acceptable sigmoid transformation function (f(x)) and an associated optimization ƒ₀ having a penalty term (third term) that tends to drive the sigmoid “reciprocal width”, or “focus”, nₖ, toward zero. The initial values appearing in FIG. 4J may be applied to the sigmoid optimization function depicted in FIG. 4I. Other terms not appearing in FIG. 4I may be found in FIG. 4F.

As mentioned above, asymptotic transformation functions, such as sigmoid and hyperbolic functions, are particularly useful in describing biological structure-activity relationships in which there exists a threshold value of a particular molecular property needed to convey activity. In contrast, unimodal transformation functions, such as Gaussian functions, are particularly useful in describing biological structure-activity relationships in which there exists an optimum value of a particular molecular property to convey the activity.

While the above discussion has focused on pKi as an activity, please understand that the invention is not so limited. Optimization routines of the type described can be performed for all types of different activities, with the same good results. Binding affinity of substrate molecules for CYP2D6 is but a single example of an activity.

As mentioned above, the transformation functions need not be limited to raw descriptor values as arguments. In some cases, the arguments of the transformation function may be principal components or other vectors through descriptor space that capture significant variation in the data set. In such cases, employs the same or a similar minimization function, except that the values of the vectors X would be comprised of not raw descriptors values, but rather principal components or other linear combinations of descriptors.

Note that in some models of this invention only a single transformed descriptor may be used. The model may use this transformed descriptor value in an expression that may include other non-transformed descriptor values, for example. In preferred embodiments, two or more transformed descriptors are employed in the model, regardless of whether non-transformed descriptors are also employed.

C. Using Models to Predict Activity

One aspect of this invention pertains to using methods and models for predicting activities of compounds. Such methods may be characterized as follows. First, the implementing system identifies the chemical compound in question. Second, it identifies values for one or more descriptors of the compound. These are the descriptors used in the method/model. Third, the system converts the descriptor raw values to transformed descriptor values using non-linear parametric transformation functions. Fourth, the system combines the transformed descriptor values for the compound in question (in the manner required by the model format) to predict the activity of the compound in question. In some models the transformed descriptor values will be combined with other, non-transformed descriptor values. Finally, the system outputs calculated activity value for the chemical compound. The system may display the calculated activity value for the compound.

Note that the separation of the third and fourth operations is largely conceptual. Typically, the model is an expression comprising embedded transformation functions. So the descriptor values of a compound in question are provided to the model, which then performs the third and fourth operations at one time to generate the predicted value of activity.

As indicated above, some important embodiments of the invention pertain to the biochemical processing of arbitrary compounds. The models of this invention may predict the overall metabolism rate of the compounds or, more narrowly, binding to a particular metabolizing enzyme such as a CYP enzyme. Such binding model may represent a consensus binding to multiple genetic isoforms of an enzyme, or, more likely, binding to a specific isoform of an enzyme.

Note that approximately 50% of all drugs are metabolized at least partly by the P450 enzymes, and 30% of drugs are metabolized primarily by these enzymes. The most important CYP enzymes in drug metabolism are the CYP3A4, CYP2D6 and CYP2C9 enzymes. In accordance with an embodiment of this invention, a separate specific model is employed for one or more of these CYP enzymes.

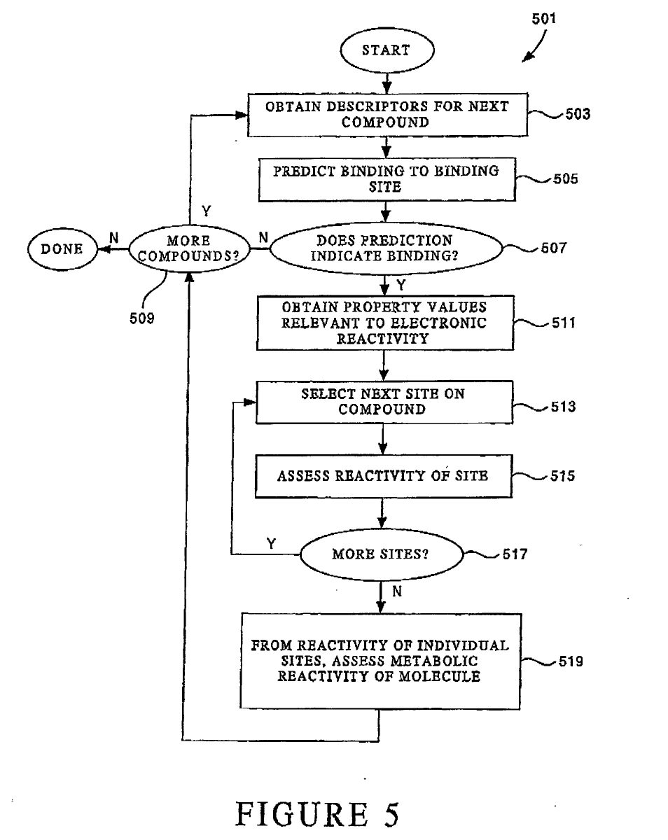

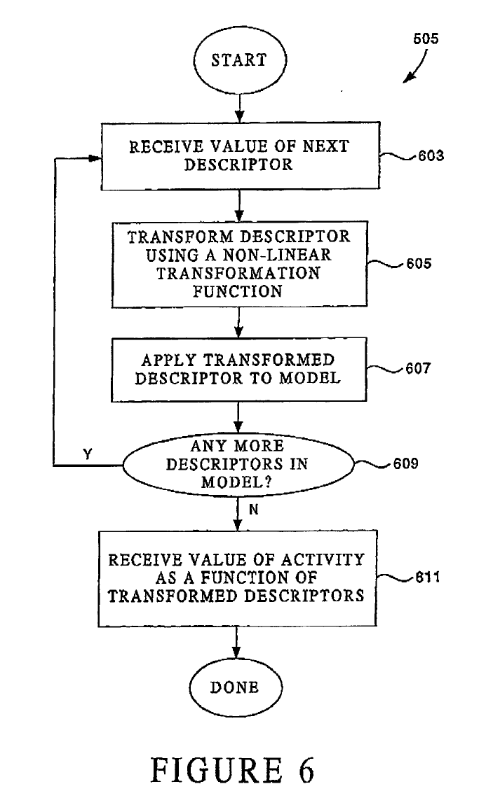

FIG. 5 presents a process flow for a specific way of using a binding affinity model of the present invention in the context of a larger process for predicting whether a particular site on a compound will be metabolized. As shown in FIG. 5, a process 501 begins at 503 with receipt of descriptors for the current compound under consideration. In the context of this model, these descriptors are pertinent to the binding of the compound to one or more CYP enzymes. At 505, a model constructed in accordance with this invention predicts the binding of the current compound to the binding site of interest. This process will be described in more detail with reference to FIG. 6. As noted above, the models of this invention may predict a value associated with binding affinity (e.g., Ki) or a simple yes/no (binding or no binding) result. Regardless of which form the model takes, the process determines at 507 whether the prediction indicates that binding will occur. This acts as a first pass filter for the metabolism model. Assuming that the binding model predicts that the compound under consideration is not, in fact, likely to bind to the binding site of this CYP enzyme, that compound is not considered further. This saves the process from expending additional computational resources on analyzing a compound that will not likely be metabolized by a CYP enzyme under consideration. So, assuming that the process determines that the compound under consideration will not bind (at 507), the process moves on to additional compounds, assuming that such compounds remain to be analyzed. See 509. If additional compounds remain, process control returns to block 503 where the binding descriptors for the next compound under consideration are received. The process then proceeds through operations 505 and 507 as described above. If no more compounds remain to be considered (i.e., decision 509 is answered in the negative), the process is then completed as illustrated.

Assuming that the compound under consideration has been found to bind sufficiently strongly to the CYP enzyme of interest, process control is directed to 511 where process 501 receives property values relevant to site specific metabolism of the compound under consideration. These property values vary depending upon the form of the metabolism model. If the model employs quantum mechanical analysis, then the relevant properties will include at least an electron distribution about potential reactive sites on the molecule. If, on the other hand, the model is a descriptor-based model, then these property values will be atom or site-specific structural descriptors of the molecule. For quantum mechanical models, the input information requires a detailed three-dimensional structural/electronic representation as described U.S. patent application Ser. No. 09/258,690 and U.S. patent application Ser. No. 09/613,875, previously incorporated by reference. The descriptors required for the second form of model are described in U.S. patent application Ser. No. 09/811,283, previously incorporated by reference.

After the relevant input properties have been received, the process must apply the relevant subset of these properties to analyze a particular site on the compound. Thus, as depicted in 501, the next operation involves selecting a particular site on the compound. See 513. With the relevant structural properties for that site at its disposal, the process assesses the reactivity of that site at 515. This assessment is preferably made in accordance with the principals described in one or more of U.S. patent application Ser. No. 09/258,690, U.S. patent application Ser. No. 09/613,875, and U.S. patent application Ser. No. 09/811,283. After the reactivity of the site in question has been ascertained and stored for further consideration, the process determines whether there are additional sites on the compound that require consideration. See 517. If so, process control returns to 513 where the next site is selected and its reactivity is assessed, at 515.

After all sites on the compound under consideration have been analyzed for reactivity (i.e., decision 517 is answered in the negative), the process assesses the metabolic reactivity of the molecule as a whole at 519. It accomplishes this by considering the individual reactivities of the various sites analyzed in operation 515. The reactivity of each site on the molecule contributes to the overall metabolic reactivity of the molecule. Note that the model may employ corrections for accessibility as described in U.S. patent application Ser. No. 09/902,470, previously incorporated by reference. After 519, the process determines whether any more compounds remain to be considered at 509. When all compounds have been considered, 509 is answered in the negative and the process is completed as mentioned above.

FIG. 6 further elaborates the details of operation 505 depicted in FIG. 5. This is the use of a model to predict binding of a molecule under consideration to a binding site of interest, a CYP metabolic enzyme in this case. Note however that the operations depicted in FIG. 6 can be applied to predict the activity of a particular compound in a context other than binding to CYP enzyme active sites, such as other metabolizing enzymes, or transporter enzymes, binding to specific proteins, or permeation across biological membranes. As shown in FIG. 6, process 505 begins at 603 with receipt of a value for the next descriptor under consideration. As described above in the context of methods for constructing models of this invention, most models include two or more descriptors in order to provide a trustworthy prediction of activity. To consider these multiple descriptors, the process 505 is depicted as a looping operation over multiple descriptors. Although typically the model will consider all descriptors simultaneously.

After the value of the current descriptor has been received, the process next transforms that descriptor using a non-linear parametric transformation function. See 605. As mentioned above, these transformation functions may take many different forms. The form matches the physical reality underlying the relationship between the descriptor and the activity in question. Very often, the form is a unimodal function such as a Gaussian distribution. To transform the descriptor, in accordance with operation 605, the numeric value of the descriptor is provided to the transformation function as an independent variable, and that transformation function returns a corresponding value for the dependent variable. That value is in fact the transformed descriptor.

At 607, the transformed descriptor is applied to the model in question. As mentioned above, the model may take various forms such as a linear combination of descriptor terms, a multiplicative combination of transform descriptors, etc.

At 609, the process determines whether any more descriptors remain to be considered for the current model. If so, process control returns to 603 where the value of the next descriptor in question is received. If not, process 505 then receives the final value of activity as a function of transformed descriptors as provided by the overall form of the model. See 611. At this point, the process is complete and the system can now determine whether or not the compound in question will bind with sufficient affinity to the binding site of interest.

Note again that operations 603, 605, 607, and 609 conceptually represent as separate, what is often performed by solving a single expression. That expression is the model and it includes embedded transformation functions for the various descriptors. 603-609 can be viewed as solving the expression for the various specific descriptor values associated with a single compound in a single operation.

Obviously, activities other than binding to CYP enzymes will use the models of this invention in a different manner than illustrated in FIGS. 5 and 6. For many activities, the models of this invention will be sufficient in and of themselves to predict the activity of interest. For example, when the activity is simply binding to a particular target (e.g., receptor), then the models of this invention can predict the activity by themselves. There is no need for a separate model such as a model of electronic reactivity.

The models of this invention can serve as useful screens. They may identify a number of candidate compounds. However, the compounds selected by this invention as likely having a desirable activity may need to be tested in vitro or in vivo. One of skill in the art will recognize that there are many different ways to experimentally confirm the activity predicted by the invention. Compounds may be tested for predicted ADMET/PK activity by using biochemical assays such as Human Serum Albumin binding, chemical assays such as pK_{A} and solubility testing, and in vitro biological assays such as metabolism by endoplasmic reticulum fractions of human liver, in order to estimate their actual in vivo ADME/PK properties.

D. Applications and Examples

As explained above, FIG. 4A depicts the fitting of activity versus molecular weight data to Gaussian transformation function. More specifically, the left-hand graph of FIG. 4A shows two histograms of compound count (density) versus molecular weight. The lower curve (histogram) on the left-hand side shows the distribution of compound within a training set of confirmed active compounds. These compounds have been confirmed to bind with CYP2D6. As can be seen, the density of compounds within this training set peaks at a molecular weight of very nearly 300. The upper curve in the left-hand graph is a distribution of known drug compounds. As can be seen, this is a much larger training set than the set of confirmed active compounds (the lower curve). Note that the distribution of known drug compounds has a peak shifted further toward the higher molecular weight side of the graph. It is assumed that the vast majority of the known drug compounds (probably about three-quarters of these compounds) do not bind with CYP2D6. Hence, this group of compounds is generally presumed inactive.

Based upon the information contained in the distributions shown in the left-hand graph, one can predict a likelihood of binding at any given molecular weight. This is accomplished using both of the histograms. To properly scale the two curves (and thereby account for the different sizes of the training sets), the curves were first scaled so that each covers the same area. Then the height of the lower curve was divided by the sum of the heights of lower and upper curves. This was performed at each molecular weight. The resulting plot was then fit to a Gaussian function using Newton's method. The resulting Gaussian distribution is depicted in the right hand graph of FIG. 4A.

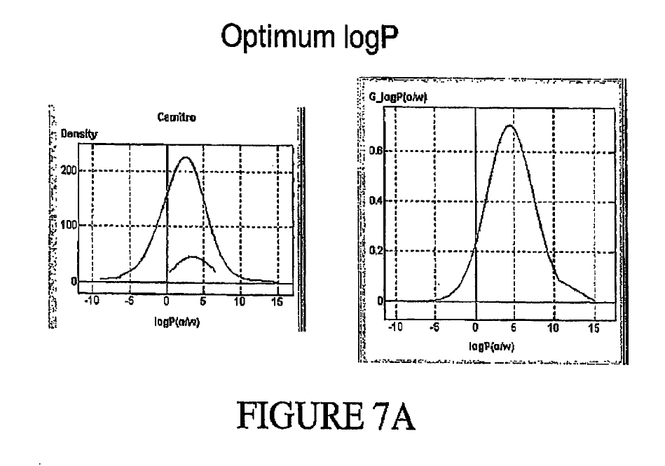

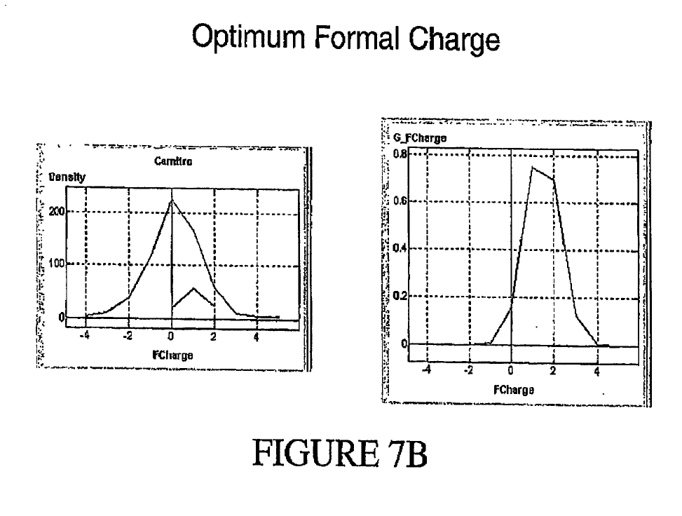

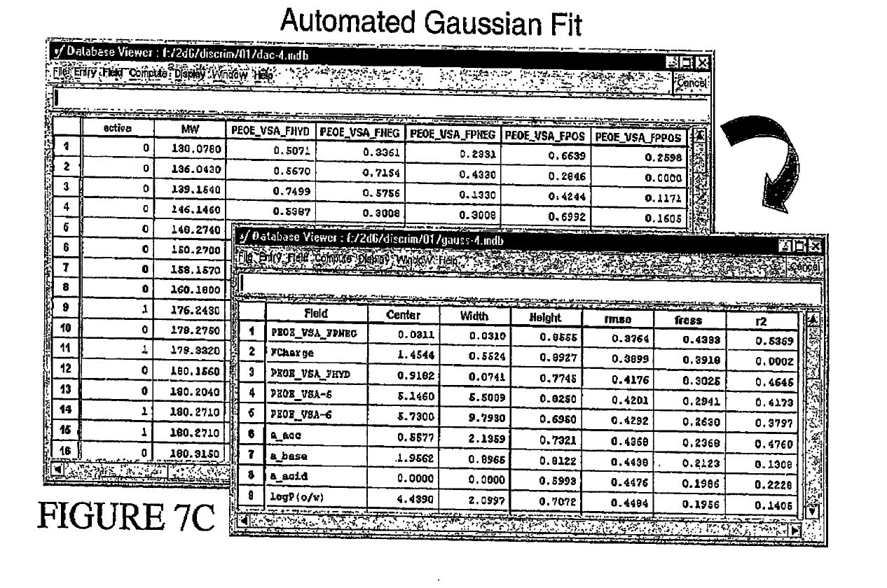

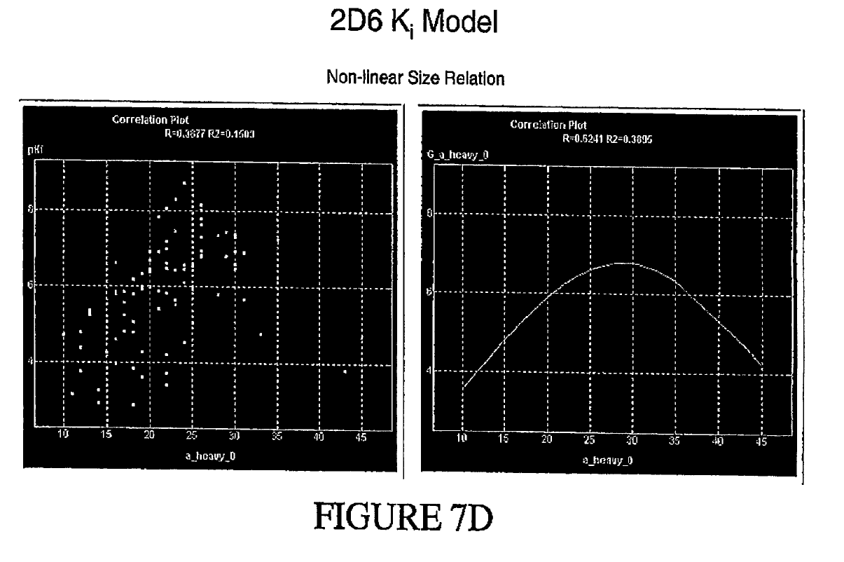

FIG. 7A depicts a similar pair of graphs. In this case, the descriptor is logP (logarithm of the partition coefficient). Again, the left curve represents a distribution of actual data and the right graph is a Gaussian function developed by fitting that data. The upper curve of the left hand graph is a distribution of the same set of drugs represented in the upper distribution of the left hand graph of FIG. 4A. In this case (FIG. 7A), the compound count is a function of the descriptor logP. The lower curve in the left-hand graph of FIG. 7A is, again, a distribution of the compound known to inhibit CYP2D6.

To fit the data in the left-hand graph, the two distributions were, as before, normalized to produce the same area under each curve. Then, the density values for the known inhibitors were divided by the sum of the densities of the known inhibitors and the known drugs. The resulting quotient was plotted versus logP and then fit to a Gaussian function. Plugging the available descriptor values into the resulting Gaussian function produced the curve depicted in the right hand graph of FIG. 7A.

FIG. 7B depicts a similar pair of graphs for the descriptor formal charge. Note the formal charge on a compound must be a whole number. Therefore, the curves have a non-smooth appearance. As can be seen from the left-hand graph of FIG. 7B, the known inhibitors have formal charges of 0, 1, or 2. The set of known drug compounds has a wider distribution of formal charges, ranging from negative 4 to positive 5.

As with the logP and molecular weight distributions, the two distributions shown in the left hand graph were first normalized and then combined as a ratio of the density of the known inhibitors and the sum of the density of the known inhibitors and drugs. The resulting distribution was then fit to a Gaussian function to produce the appropriate formal charge transformation function. That function is depicted in the right hand graph of FIG. 7B. Note that the function shown in the right hand graph is plotted only at the available whole number values of formal charge.

FIG. 7C depicts an automated software technique that was employed to convert a data set of descriptor values versus activities for a training set of compounds to corresponding Gaussian transformation functions. The background spreadsheet in FIG. 7C depicts the raw data set as a collection of rows, each row representing a different compound from the training set. The left most column indicates whether the compound is active or inactive at inhibiting CYP2D6. The remaining columns represent particular descriptor values such as logP, amount and types of formal charges, number of acidic atoms, number of hydrogen bond donor atoms, number of hydrogen bond acceptor atoms, total negative polar van der Waals surface area, etc.

The spreadsheet in the foreground shows the parameters derived by fitting the data from the data set to separate Gaussian functions for each of the descriptors. Thus, in the foreground spreadsheet, each row represents a different descriptor. The left most column identifies the descriptors in question. The column labeled “center” provides the parameter μ. The column labeled “width” identifies σ for each transformation function. The column labeled “height” identifies h, the height of the Gaussian function at the center of each transformation function. The column labeled “rmse” is the root mean square error for each of the derived Gaussian functions. The column labeled “fress”, or fitted residual sum-of-squared error, describes the fraction of variation in the fitted data that is explained by the model, and is equivalent to Q², or PRESS, for predicted values.

So far in a discussion of the examples, the compounds have been designated as either active or inactive. No identification of a Ki value of other numerical value of activity was provided. Thus, the data was merely provided as a histogram, representing the number of compounds at any given descriptor value. FIG. 7D illustrates that other data sets having numerical values of activity can also be fit to transformation functions; a Gaussian transformation function in this case. The left-hand graph represents a plot of pKi data versus a modified molecular weight for the compounds of the training set. The right hand graph represents a Gaussian function fit to the distribution of Ki values for the descriptor in question. Such Gaussian transformation function can be employed to generate a model that predicts actual values of Ki, as opposed to merely providing a probability of binding value. Sample substances for which models of this invention may predict activity include various drug compounds or pharmaceutically active agents as well as any molecule introduced (such as by ingestion, injection or inhalation) into a living organism. Upon such introduction, the substances may undergo reactions or interactions with various biological molecules such as enzymes. Important applications of this invention provide and use models that predict such reactions and/or interactions.

The models of this invention may be used for various high throughput applications. For example, the models are useful for processing large chemical libraries derived from combinatorial synthesis. Alternatively, the models can be used for high confidence screens of hits that have been identified by a drug development concern.

E. Hardware/Software Implementation

Certain embodiments of the present invention employ processes acting or acting under control of data stored in or transferred through one or more computer systems. Embodiments of the present invention also relate to an apparatus for performing these operations. This apparatus may be specially designed and/or constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines will appear from the description given below.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, magnetic tape; optical media such as CD-ROM devices and holographic devices; magneto-optical media; semiconductor memory devices, and hardware devices that are specially configured to store and perform program instructions, such as read-only memory devices (ROM) and random access memory (RAM), and sometimes application-specific integrated circuits (ASICs), programmable logic devices (PLDs) and signal transmission media for delivering computer-readable instructions, such as local area networks, wide area networks, and the Internet. The data and program instructions of this invention may also be embodied on a carrier wave or other transport medium (e.g., optical lines, electrical lines, and/or airwaves). Examples of program instructions include both machine code, such as produced by a compiler, and files containing higher level code that may be executed by the computer using an interpreter.

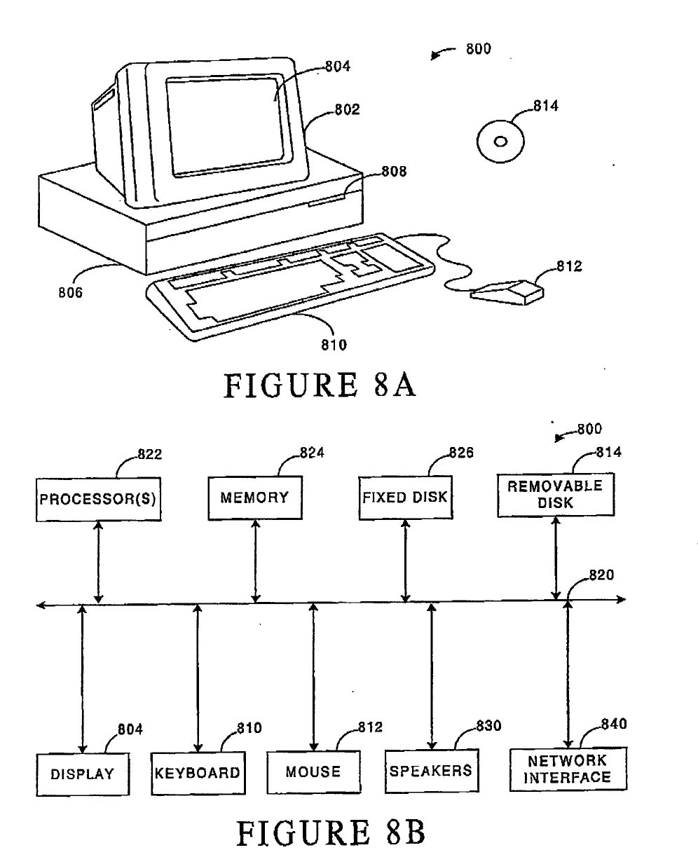

FIGS. 8A and 8B illustrate a computer system 800 suitable for implementing embodiments of the present invention. FIG. 8A shows one possible physical form of the computer system. Of course, the computer system may have many physical forms ranging from an integrated circuit, a printed circuit board and a small handheld device up to a very large super computer. Computer system 800 includes a monitor 802, a display 804, a housing 806, a disk drive 808, a keyboard 810 and a mouse 812. Disk 814 is one example of a computer-readable medium used to transfer data to and from computer system 800.

FIG. 8B is a block diagram of certain logical components of computer system 800. Attached to system bus 820 are a wide variety of subsystems. Processor(s) 822 (also referred to as central processing units, or CPUs) are coupled to storage devices including memory 824. Memory 824 includes random access memory (RAM) and read-only memory (ROM). ROM acts to transfer data and instructions uni-directionally to the CPU and RAM is used typically to transfer data and instructions in a bi-directional manner. Both of these types of memories may include any suitable computer-readable medium, including those described above. A fixed disk 826 is also coupled bi-directionally to CPU 822; it provides additional data storage capacity and may also include any of the computer-readable media described below. Fixed disk 826 may be used to store programs, data and the like and is typically a secondary storage medium (such as a hard disk) that is slower than primary storage. It will be appreciated that the information retained within fixed disk 826, may, in appropriate cases, be incorporated in standard fashion as virtual memory in memory 824. Removable disk 814 may take the form of any of the computer-readable media described below.

CPU 822 is also coupled to a variety of input/output devices such as display 804, keyboard 810, mouse 812 and speakers 830. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 822 optionally may be coupled to another computer or telecommunications network using network interface 840. With such a network interface, it is contemplated that the CPU might receive information from the network, or might output information to the network in the course of performing the above-described method steps. Furthermore, method embodiments of the present invention may execute solely upon CPU 822 or may execute over a network such as the Internet in conjunction with a remote CPU that shares a portion of the processing.

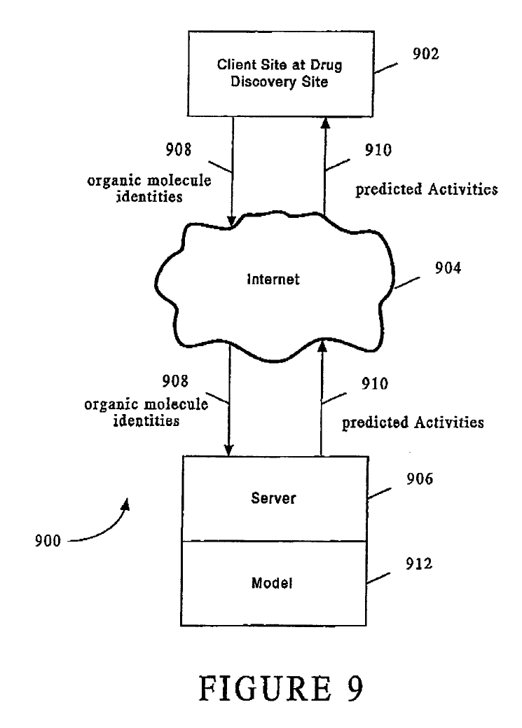

FIG. 9 is a schematic illustration of an Internet-based embodiment of the current invention. See 900. According to a specific embodiment, a client 902, at a drug discovery site, for example, sends data 908 identifying organic molecules 908 to a processing server, 906 via the Internet 904. The organic molecules are simply the molecules that the client wishes to have analyzed by the current invention. At the processing server 906, the molecules of interest are analyzed by a model 912, which predicts whether the molecules are likely to have a particular activity (e.g., an ADMET/PK property or binding affinity), for example. The processing server may also redesign compounds to improve their activities.

After the analysis, the predicted activities 910 (and any other appropriate information) are sent via the Internet 904 back to the client 902. The computer system illustrated in FIGS. 8A and 8B is suitable both for the client 902 and the processing server 906. In a specific embodiment, standard transmission protocols such as TCP/IP (transmission control protocol/internet protocol) are used to communicate between the client 902 and processing server 906. Security measures such as SSL (secure socket layer), VPN (virtual private network) and encryption methods (e.g., public key encryption) can also be used.

F. Other Embodiments

Although the above has generally described the present invention according to specific processes and apparatus, the present invention has a much broader range of applicability. In particular, the present invention is not limited to a particular class of activity or descriptor. Thus, in some embodiments, the techniques of the present invention could provide information about many different types or groups of activities. Of course, one of ordinary skill in the art would recognize other variations, modifications, and alternatives.

What is claimed is:

1. A method of predicting the activity of a compound, the method comprising:
(a) providing a model for predicting activity of compounds based on one or more descriptors of physicochemical properties of compounds;
(b) characterizing the compound by one or more descriptor values;
(c) transforming the one or more descriptor values via one or more non-linear parametric functions, each of which provides an analytical relationship between the activity and the corresponding descriptor value;
(d) using the model to predict the activity of the compound from the transformed descriptors.

2. The method of claim 1, wherein the activity is a biological activity.

3. The method of claim 1, wherein the activity is a biological activity related to ADMET/Pk.

4. The method of claim 1, wherein the activity is a binding affinity to a biological molecule.

5. The method of claim 1, wherein the activity is binding to a cytochrome P450 enzyme.

6. The method of claim 1, wherein the compound is a therapeutic compound or a compound being investigated as potential therapeutic compound.

7. The method of claim 1, wherein at least one of the descriptors specifies a property of the compound as a whole.

8. The method of claim 7, wherein at least one of the descriptors is a lipophilicity-based descriptor of the compound, a size-based descriptor of the compound, or a charge-based descriptor of the compound.

9. The method of claim 1, wherein one of the non-linear parametric functions is a piece-wise continuous function representing a kernal-smoothed activity to descriptor relationship in training data.

10. The method of claim 1, wherein one of the non-linear parametric functions is a unimodal function.

11. The method of claim 1, wherein one of the non-linear parametric functions is a Gaussian function.

12. The method of claim 1, wherein one of the non-linear parametric functions is an asymptotic function.

13. The method of claim 1, wherein one of the non-linear parametric functions is a sigmoid function.

14. The method of claim 1, wherein one of the non-linear parametric functions is a hyperbolic function.

15. The method of claim 1, wherein the model provides a linear combination of a transformed descriptor value with one or more other transformed or non-transformed descriptor values.

16. The method of claim 1, wherein the model comprises a multiplicative combination of a first transformed descriptor value with one or more other transformed or non-transformed descriptor values.

17. The method of claim 16, wherein the model comprises a multivariate unimodal distribution.

18. The method of claim 16, wherein the model comprises a multivariate Gaussian function.

19. The method of claim 16, wherein the model the model comprises a multivariate asymptotic function.

20. The method of claim 16, wherein the model the model comprises a multivariate sigmoid function.

21. The method of claim 16, wherein the model the model comprises a multivariate hyperbolic function.

22. The method of claim 1, wherein (c)-(e) are performed in a single operation.

23. A computer program product comprising a machine readable medium on which is provided program instructions for predicting the activity of a compound, the program instructions comprising instructions for
(a) providing a model for predicting activity of compounds based on one or more descriptors of physicochemical properties of compounds;
(b) characterizing the compound by one or more descriptor values;
(c) transforming the one or more descriptor values via one or more non-linear parametric functions, each of which provides an analytical relationship between the activity and the corresponding descriptor value;
(d) using the model to predict the activity of the compound from the transformed descriptors.

24. The computer program product of claim 23, wherein the activity is a biological activity related to ADMET/PK.

25. The computer program product of claim 23, wherein the activity is a binding affinity to a biological molecule.

26. The computer program product of claim 23, wherein the activity is binding to a cytochrome P450 enzyme.

27. The computer program product of claim 23, wherein one of the non-linear parametric functions is a unimodal function.

28. The computer program product of claim 23, wherein one of the non-linear parametric functions is a Gaussian function.

29. The computer program product of claim 23, wherein one of the non-linear parametric functions is an asymptotic function.

30. The computer program product of claim 23, wherein the model comprises a multiplicative combination of a first transformed descriptor value with one or more other transformed or non-transformed descriptor values.

31. A method of predicting the activity of a compound, the method comprising:
(a) providing a model for predicting activity of compounds based on two or more descriptors of physicochemical properties of compounds, wherein the model comprises (i) a first non-linear transformation function which transforms values of a first descriptor and provides an analytical relationship between the activity and the first descriptor and (ii) a second non-linear transformation function which transforms values of a second descriptor and provides an analytical relationship between the activity and the second descriptor;
(b) characterizing the compound by a first descriptor value and a second descriptor value; and
(c) predicting the activity of the compound by using the first and second descriptor values as arguments in the model.

32. The method of claim 31, wherein at least one of the first and second descriptor values comprise a vector through descriptor space.

33. A computer program product comprising a machine readable medium on which is provided program instructions for predicting the activity of a compound, the program instructions comprising the following instructions:
(a) providing a model for predicting activity of compounds based on two or more descriptors of physicochemical properties of compounds, wherein the model comprises (i) a first non-linear transformation function which transforms values of a first descriptor and provides an analytical relationship between the activity and the first descriptor and (ii) a second non-linear transformation function which transforms values of a second descriptor and provides an analytical relationship between the activity and the second descriptor;
(b) characterizing the compound by a first descriptor value and a second descriptor value; and
(c) predicting the activity of the compound by using the first and second descriptor values as arguments in the model.

34. The computer program product of claim 33, wherein at least one of the first and second descriptor values comprise a vector through descriptor space.

35. A method of predicting the activity of a compound, the method comprising:
(a) providing a model for predicting activity of compounds based on two or more descriptors of physicochemical properties of compounds;
(b) characterizing the compound by the two or more descriptor values;
(c) generating one or more orthogonal, linear transformations of the descriptor values;
(d) transforming the linear transforms via one or more non-linear parametric functions, each of which provides an analytical relationship between the activity and the corresponding linear transform;
(e) using the model to predict the activity of the compound from the linearly transformed descriptors and subsequent non-linear transforms of the linearly transformed descriptors.

36. A method of creating a multivariate model for predicting the activity of compounds, the method comprising:
(a) for each compound for a plurality of compounds, obtaining an indication of the activity of the compound and values of one or more descriptors of the compound;
(b) for each of the descriptors, using activity versus descriptor data for the plurality of compounds to identify a non-linear parametric function representing an analytical relationship between the activity and the descriptor data;
(c) for each of the descriptors, transforming the descriptor via the non-linear parametric function; and
(d) creating the multivariate model of activity as a function of the descriptors and the non-linear parametric function transforms of the descriptors.

37. The method of claim 36, wherein the activity is a biological activity.

38. The method of claim 36, wherein the activity is a biological activity related to ADMET/PK.

39. The method of claim 36, wherein the activity is binding affinity to a biological molecule.

40. The method of claim 36, wherein the activity is binding to a cytochrome P450 enzyme.

41. The method of claim 36, wherein the plurality of compounds comprises at least one of (i) known therapeutic compounds and (ii) compounds being investigated as potential therapeutic compounds.

42. The method of claim 36, wherein at least one of the descriptors specifies a property of compounds as a whole.

43. The method of claim 42, wherein at least one of the descriptors is a lipophilicity-based descriptor, a size-based descriptor, or a charge-based descriptor.

44. The method of claim 36, wherein one of the non-linear parametric functions is a piece-wise continuous function representing a kernal-smoothed activity to descriptor relationship in a training data.

45. The method of claim 36, wherein one of the non-linear parametric functions is a unimodal function.

46. The method of claim 36, wherein one of the non-linear parametric functions is a Gaussian function.

47. The method of claim 36, wherein one of the non-linear parametric functions is an asymptotic function.

48. The method of claim 36, wherein one of the non-linear parametric functions is a sigmoid function.

49. The method of claim 36, wherein one of the non-linear parametric functions is a hyperbolic function.

50. The method of claim 36, wherein the model comprises a linear combination of a first non-linear transformed descriptor and one or more other transformed or non-transformed descriptors.

51. The method of claim 50, wherein the model comprises a linear combination of the first transformed descriptor and the one or more other transformed or non-transformed descriptor, each multiplied by a corresponding coefficient.

52. The method of claim 36, wherein the model comprises a multiplicative combination of the first transformed descriptor and the one or more other transformed or non-transformed descriptors.

53. The method of claim 52, wherein the model comprises a multivariate unimodal distribution.

54. The method of claim 52, wherein the model the model comprises a multivariate Gaussian function.

55. The method of claim 52, wherein the model the model comprises a multivariate asymptotic function.

56. The method of claim 52, wherein the model the model comprises a multivariate sigmoid function.

57. The method of claim 52, wherein the model the model comprises a multivariate hyperbolic function.

58. The method of claim 36, wherein creating the multivariate model comprises performing an optimization routine to determine the parameters for the non-linear parametric functions.

59. The method of claim 36, wherein (b)-(d) are performed together in a parameter optimization operation.

60. The method of claim 36, wherein the indication of the activity of the compound is a numerical value of activity.

61. The method of claim 36, wherein the indication of the activity of the compound is whether or not the compound possesses the activity.

62. The method of claim 36, further comprising, prior to (d), automatically identifying one or more descriptors as having little effect on the activity, and removing the one or more descriptors from use in the multivariate model.

63. A method of creating a model for predicting the activity of compounds, the method comprising:
(a) for each compound for a plurality of compounds, obtaining an indication of the activity of the compound and values of two or more descriptors of the compound; and
(b) creating the multivariate model of activity as a function of the first and second descriptors by using the values of the two or more descriptors and the indication of the activity for each of the plurality of compounds and fitting the descriptors and indications of activity to two or more non-linear parametric functions of the descriptors, which non-linear parametric functions are present in the model, wherein each of the non-linear parametric functions provides an analytical relationship between the activity and the corresponding descriptor value.

64. The method of claim 63, wherein creating the multivariate model comprises performing a minimization routine on descriptor and activity data from the plurality of compounds.

65. The method of claim 64, wherein the activity data comprises numerical values of activity.

66. The method of claim 64, wherein the activity data comprises an average expected numerical value of activity for at least some of the plurality of compounds.

67. The method of claim 66, wherein the activity data further comprises numerical values of activity for others of the plurality of compounds.

68. The method of claim 63, wherein the activity is binding to a CYP enzyme and at least one of the non-linear parametric transformation functions is a Gaussian function.

69. A method of creating a model for predicting the activity of a compound, the method comprising:
(a) for each compound for a plurality of compounds, obtaining an indication of the activity of the compound and values of two or more descriptors of the compound;
(b) generating one or more orthogonal, linear transformations of the descriptor values;
(c) for each of the linear descriptor transforms, using activity data versus the linear transform for the plurality of compounds to identify a non-linear parametric function, which provides an analytical relationship between the activity and the corresponding linear descriptor transform;
(d) for each of the linear descriptor transforms, transforming it via the non-linear parametric function; and
(e) creating the multivariate model of activity as a function of the linearly transformed descriptors and the subsequent non-linear transforms of these linearly transformed descriptors.

70. The method of claim 69, wherein generating the orthogonal linear transformations comprises applying a principal component analysis to the plurality of compounds.

71. A method of creating a multivariate model for predicting the activity of compounds, the model including at least one non-linear parametric transformation function that transforms a descriptor of the compounds, the method comprising:
(a) fitting activity versus descriptor data for a training set of compounds using an optimization function comprising (i) a penalty term that drives a parameter of the transformation function toward a boundary value, and (ii) an error term that compares a predicted activity with an actual activity for members of the training set;
(b) identifying one or more descriptors whose parameters were driven toward the boundary value by the penalty function to values below a threshold of significance to the model;
(c) eliminating the one or more descriptors identified in (b) from use with the multivariate model.

72. The method of claim 71, further comprising performing (a)-(c) at least twice.

73. The method of claim 71, further comprising fitting a model with the descriptors remaining after (c).

74. The method of claim 71, further comprising cross-validating a model using the descriptors remaining after (c).

75. The method of claim 74, further comprising de-selecting descriptors driven toward the boundary value during the cross-validation .

76. The method of claim 71, wherein the parameter of the transformation function driven by the penalty term is the width of the non-linear parametric transformation function for each descriptor.

77. The method of claim 76, wherein the penalty term includes terms representing the reciprocal of the width of the non-linear parametric transformation function.

78. The method of claim 71, wherein the non-linear parametric transformation function is a unimodal function.

79. The method of claim 71, wherein the non-linear parametric transformation function is a Gaussian function.

80. The method of claim 71, wherein the non-linear parametric transformation function is an asymptotic function.

81. The method of claim 71, wherein the non-linear parametric transformation function is a sigmoid function.

82. The method of claim 71, wherein the non-linear parametric transformation function is a hyperbolic function.

83. The method of claim 71, wherein (a)-(c) are performed automatically by a computing device, without user intervention.

84. The method of claim 74, wherein cross-validation is performed automatically by a computing device, without user intervention.

85. The method of claim 75, wherein de-selection of descriptors after cross-validation is performed automatically by a computing device, without user intervention.

86. The method of claims 74, wherein multiple rounds of model fitting, cross-validation, and descriptor de-selection are performed automatically by a computing device, without user intervention, until the process converges to a model based on a minimum set of descriptor identified as significant for the model.

87. The method of claim 71, wherein the optimization function further comprises scaling factors which specify the relative importance of the penalty terms with respect to the error term.

88. The method of claim 71, wherein the optimization function further comprises a parameter constraint term that promotes the numerical stability of the fit.

89. A computer program product comprising a machine readable medium on which is provided program instructions for creating a multivariate model for predicting the activity of compounds, the model including at least one non-linear parametric transformation function that transforms a descriptor of the compounds, the program instructions comprising instructions for
(a) fitting activity versus descriptor data for a training set of compounds using an optimization function comprising (i) a penalty term that drives a parameter of the transformation function toward a boundary value, and (ii) an error term that compares a predicted activity with an actual activity for members of the training set;
(b) identifying one or more descriptors whose parameters were driven toward the boundary value by the penalty function to values below a threshold of significance to the model;
(c) eliminating the one or more descriptors identified in (b) from use with the multivariate model.

90. The computer program product of claim 89, further comprising instructions for performing (a)-(c) at least twice.

91. The computer program product of claim 89, further comprising instructions for fitting a model with the descriptors remaining after (c).

92. The computer program product of claim 89, further comprising instructions for cross-validating a model using the descriptors remaining after (c).

93. The computer program product of claim 92, further comprising instructions for de-selecting descriptors driven toward the boundary value during the cross-validation.

94. The computer program product of claim 89, wherein the parameter of the transformation function driven by the penalty term is the width of the non-linear parametric transformation function for each descriptor.

95. The computer program product of claim 89, wherein the non-linear parametric transformation function is a unimodal function.

96. The computer program product of claim 89, wherein the non-linear parametric transformation function is a Gaussian function.

97. The computer program product of claim 89, wherein the non-linear parametric transformation function is an asymptotic function.

98. The computer program product of claim 89, wherein the non-linear parametric transformation function is a sigmoid function.

99. The computer program product of claim 89, wherein the non-linear parametric transformation function is a hyperbolic function.

100. The method of claim 1, wherein the activity is a binding affinity to a drug metabolizing enzyme.

101. The computer program product of claim 23, wherein the activity is a binding affinity to a drug metabolizing enzyme.

102. The computer program product of claim 23, wherein one of the non-linear parametric functions is a sigmoid function.

103. The computer program product of claim 23, wherein one of the non-linear parametric functions is a hyperbolic function.

104. The method of claim 36, wherein the activity is binding affinity to a drug metabolizing enzyme.
